(19) United States
(12) Patent Application Publication
(10) Pub. No.: US 2026/0353123 A1
(43) Pub. Date: Nov. 5, 2026

(54) BEAM MANAGEMENT INFERENCE MODEL COORDINATION IN A DISAGGREGATED NETWORK

(71) Applicant: QUALCOMM Incorporated, San Diego, CA (US)

(72) Inventors: Geetha Priya RAJENDRAN, Bangalore (IN); Rajeev KUMAR, San Diego, CA (US); Prasada Veera Reddy KADIRI, San Diego, CA (US)

(21) Appl. No.: 19/195,491

(22) Filed: Apr. 30, 2025

(51) Int. Cl. H04W 24/08; H04W 24/02

(52) U.S. Cl. CPC H04W 24/08; H04W 24/02

(57) ABSTRACT

Various aspects of the present disclosure generally relate to wireless communication. In some aspects, a network node may transmit an indication of a training data configuration for collecting training data that is associated with generation of a beam management inference model. The network node may receive the training data that is based at least in part on the training data configuration. The network node may generate the beam management inference model using the training data. The network node may transmit, as at least part of a deployment of the beam management inference model, the indication of the training data configuration. Numerous other aspects are described.

### FIELD OF THE DISCLOSURE

Aspects of the present disclosure generally relate to wireless communication and specifically relate to techniques, apparatuses, and methods associated with beam management inference model coordination in a disaggregated network.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A wireless communication system may use a beam to direct radio frequency signals toward a specific user equipment rather than broadcasting signals in all directions. To illustrate, a beam is a directed radio frequency signal that concentrates energy in a specific direction by selectively combining multiple signals using constructive and destructive properties of the signals to increase signal strength in a desired direction and decrease signal strength in an undesired direction. Conversely, an omnidirectional signal radiates energy uniformly in all directions, providing coverage over a wide area but with lower signal strength and higher potential for interference, as compared to a directed beam. A transmitter may perform beamforming (e.g., concentrating radio frequency energy in a specific direction by selectively combining multiple signals using constructive and destructive properties of the signals) to direct a beam to an intended receiver, resulting in reduced interference with other devices.

### SUMMARY

The systems, methods, and devices of this disclosure each have several innovative aspects, no single one of which is solely responsible for the desirable attributes disclosed herein.

Some aspects described herein relate to a method of wireless communication by a network node. The method may include transmitting an indication of a training data configuration for collecting training data that is associated with generation of a beam management inference model. The method may include receiving the training data that is based at least in part on the training data configuration. The method may include generating the beam management inference model using the training data. The method may include transmitting, as at least part of a deployment of the beam management inference model, the indication of the training data configuration.

Some aspects described herein relate to a method of wireless communication by a network node. The method may include receiving a beam management inference model and an indication of a training data configuration that is associated with the beam management inference model. The method may include deriving an activation state for using the beam management inference model based at least in part on at least one of, a current operating condition, or one or more criteria indicated by the training data configuration. The method may include applying the beam management inference model for beam management selectively and based at least in part on the activation state.

Some aspects described herein relate to a method of wireless communication by a network node. The method may include selecting one or more user equipments (UEs) for collecting training data that is associated with generation of a beam management inference model. The method may include transmitting an indication of a training data configuration to configure the one or more UEs for collecting the training data. The method may include receiving the training data, the training data being based at least in part on the training data configuration. The method may include generating the beam management inference model using the training data.

Some aspects described herein relate to a method of wireless communication by a network node. The method may include selecting one or more UEs for collecting training data that is associated with generation of a beam management inference model. The method may include transmitting an indication of a training data configuration to configure the one or more UEs for collecting the training data. The method may include receiving the training data, the training data being based at least in part on the training data configuration. The method may include generating the beam management inference model using the training data. The method may include applying the beam management inference model for beam management selectively using an activation state, the activation state being based at least in part on at least one of, a current operating condition, or one or more criteria indicated by the training data configuration.

Some aspects described herein relate to a non-transitory computer-readable medium that stores a set of instructions for wireless communication by a network node. The set of instructions, when executed by one or more processors of the network node, may cause the network node to transmit an indication of a training data configuration for collecting training data that is associated with generation of a beam management inference model. The set of instructions, when executed by one or more processors of the network node, may cause the network node to receive the training data that is based at least in part on the training data configuration. The set of instructions, when executed by one or more processors of the network node, may cause the network node to generate the beam management inference model using the training data. The set of instructions, when executed by one or more processors of the network node, may cause the network node to transmit, as at least part of a deployment of the beam management inference model, the indication of the training data configuration.

Some aspects described herein relate to a non-transitory computer-readable medium that stores a set of instructions for wireless communication by a network node. The set of instructions, when executed by one or more processors of the network node, may cause the network node to receive a beam management inference model and an indication of a training data configuration that is associated with the beam management inference model. The set of instructions, when executed by one or more processors of the network node, may cause the network node to derive an activation state for using the beam management inference model based at least in part on at least one of, a current operating condition, or one or more criteria indicated by the training data configuration. The set of instructions, when executed by one or more processors of the network node, may cause the network node to apply the beam management inference model for beam management selectively and based at least in part on the activation state.

Some aspects described herein relate to a non-transitory computer-readable medium that stores a set of instructions for wireless communication by a network node. The set of instructions, when executed by one or more processors of the network node, may cause the network node to select one or more UEs for collecting training data that is associated with generation of a beam management inference model. The set of instructions, when executed by one or more processors of the network node, may cause the network node to transmit an indication of a training data configuration to configure the one or more UEs for collecting the training data. The set of instructions, when executed by one or more processors of the network node, may cause the network node to receive the training data, the training data being based at least in part on the training data configuration. The set of instructions, when executed by one or more processors of the network node, may cause the network node to generate the beam management inference model using the training data.

Some aspects described herein relate to a non-transitory computer-readable medium that stores a set of instructions for wireless communication by a network node. The set of instructions, when executed by one or more processors of the network node, may cause the network node to select one or more UEs for collecting training data that is associated with generation of a beam management inference model. The set of instructions, when executed by one or more processors of the network node, may cause the network node to transmit an indication of a training data configuration to configure the one or more UEs for collecting the training data. The set of instructions, when executed by one or more processors of the network node, may cause the network node to receive the training data, the training data being based at least in part on the training data configuration. The set of instructions, when executed by one or more processors of the network node, may cause the network node to generate the beam management inference model using the training data. The set of instructions, when executed by one or more processors of the network node, may cause the network node to apply the beam management inference model for beam management selectively using an activation state, the activation state being based at least in part on at least one of, a current operating condition, or one or more criteria indicated by the training data configuration.

Some aspects described herein relate to a network node. The network node may include a processing system. The processing system may include one or more processors and one or more code-storing memories coupled with the one or more processors. The processing system may be configured to cause the network node to transmit an indication of a training data configuration for collecting training data that is associated with generation of a beam management inference model. The processing system may be configured to cause the network node to receive the training data that is based at least in part on the training data configuration. The processing system may be configured to cause the network node to generate the beam management inference model using the training data. The processing system may be configured to cause the network node to transmit, as at least part of a deployment of the beam management inference model, the indication of the training data configuration.

Some aspects described herein relate to a network node. The network node may include a processing system. The processing system may include one or more processors and one or more code-storing memories coupled with the one or more processors. The processing system may be configured to cause the network node to receive a beam management inference model and an indication of a training data configuration that is associated with the beam management inference model. The processing system may be configured to cause the network node to derive an activation state for using the beam management inference model based at least in part on at least one of, a current operating condition, or one or more criteria indicated by the training data configuration. The processing system may be configured to cause the network node to apply the beam management inference model for beam management selectively and based at least in part on the activation state.

Some aspects described herein relate to a network node. The network node may include a processing system. The processing system may include one or more processors and one or more code-storing memories coupled with the one or more processors. The processing system may be configured to cause the network node to select one or more UEs for collecting training data that is associated with generation of a beam management inference model. The processing system may be configured to cause the network node to transmit an indication of a training data configuration to configure the one or more UEs for collecting the training data. The processing system may be configured to cause the network node to receive the training data, the training data being based at least in part on the training data configuration. The processing system may be configured to cause the network node to generate the beam management inference model using the training data.

Some aspects described herein relate to a network node. The network node may include a processing system. The processing system may include one or more processors and one or more code-storing memories coupled with the one or more processors. The processing system may be configured to cause the network node to select one or more UEs for collecting training data that is associated with generation of a beam management inference model. The processing system may be configured to cause the network node to transmit an indication of a training data configuration to configure the one or more UEs for collecting the training data. The processing system may be configured to cause the network node to receive the training data, the training data being based at least in part on the training data configuration. The processing system may be configured to cause the network node to generate the beam management inference model using the training data. The processing system may be configured to cause the network node to apply the beam management inference model for beam management selectively using an activation state, the activation state being based at least in part on at least one of, a current operating condition, or one or more criteria indicated by the training data configuration.

Some aspects described herein relate to an apparatus for wireless communication. The apparatus may include means for transmitting an indication of a training data configuration for collecting training data that is associated with generation of a beam management inference model. The apparatus may include means for receiving the training data that is based at least in part on the training data configuration. The apparatus may include means for generating the beam management inference model using the training data. The apparatus may include means for transmitting, as at least part of a deployment of the beam management inference model, the indication of the training data configuration.

Some aspects described herein relate to an apparatus for wireless communication. The apparatus may include means for receiving a beam management inference model and an indication of a training data configuration that is associated with the beam management inference model. The apparatus may include means for deriving an activation state for using the beam management inference model based at least in part on at least one of, a current operating condition, or one or more criteria indicated by the training data configuration. The apparatus may include means for applying the beam management inference model for beam management selectively and based at least in part on the activation state.

Some aspects described herein relate to an apparatus for wireless communication. The apparatus may include means for selecting one or more UEs for collecting training data that is associated with generation of a beam management inference model. The apparatus may include means for transmitting an indication of a training data configuration to configure the one or more UEs for collecting the training data. The apparatus may include means for receiving the training data, the training data being based at least in part on the training data configuration. The apparatus may include means for generating the beam management inference model using the training data.

Some aspects described herein relate to an apparatus for wireless communication. The apparatus may include means for selecting one or more UEs for collecting training data that is associated with generation of a beam management inference model. The apparatus may include means for transmitting an indication of a training data configuration to configure the one or more UEs for collecting the training data. The apparatus may include means for receiving the training data, the training data being based at least in part on the training data configuration. The apparatus may include means for generating the beam management inference model using the training data. The apparatus may include means for applying the beam management inference model for beam management selectively using an activation state, the activation state being based at least in part on at least one of, a current operating condition, or one or more criteria indicated by the training data configuration.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example architecture of a functional framework for radio access network intelligence enabled by data collection.

FIG. 4 is a diagram illustrating an example of a wireless communication process between a user equipment (UE), a first network node, and a second network node.

FIG. 5 is a diagram illustrating an example of a wireless communication process between a UE, a first network node, and a second network node.

FIG. 6 is a diagram illustrating an example of a wireless communication process between a UE, a first network node, and a second network node.

FIG. 7 is a diagram illustrating an example process performed, for example, at a network node or an apparatus of a network node.

FIG. 8 is a diagram illustrating an example process performed, for example, at a network node or an apparatus of a network node.

FIG. 9 is a diagram illustrating an example process performed, for example, at a network node or an apparatus of a network node.

FIG. 10 is a diagram illustrating an example process performed, for example, at a network node or an apparatus of a network node.

FIG. 11 is a diagram of an example apparatus for wireless communication.

### DETAILED DESCRIPTION

A wireless communication system may use a beam to direct radio frequency (RF) signals toward a specific user equipment (UE) rather than broadcasting signals in all directions. To illustrate, a beam is a directed RF signal that concentrates energy in a specific direction by selectively combining multiple signals using constructive and destructive properties of the signals to increase signal strength in a desired direction and decrease signal strength in an undesired direction. Conversely, an omnidirectional signal radiates energy uniformly in all directions, providing coverage over a wide area but with lower signal strength and higher potential for interference, as compared to a directed beam. A transmitter may perform beamforming (e.g., concentrating RF energy in a specific direction by selectively combining multiple signals using constructive and destructive properties of the signals) to direct a beam to an intended receiver, resulting in reduced interference with other devices.

In some cases, a transmitter may dynamically adjust a beam, such as by changing the direction in which the beam is focused. To illustrate, the transmitter may adjust a beam direction based on the changing location of the UE, such as by adjusting one or more phase properties, one or more amplitude priorities, or a combination of the signals being combined. The ability to adjust beams ensures consistent and reliable connectivity between the transmitter and receiver. For some scenarios, using beams may increase a reliability of a transmission (e.g., reduced data recovery errors, increased data throughput, reduced data transfer latencies) in high-frequency bands, such as in microwave frequency bands and/or above 6 gigahertz (GHz) frequency bands in which signals may be more susceptible to degradation due to obstacles and distance.

“Beam management” refers to the process of directing and adjusting RF beams to optimize signal strength (e.g., increase a transmit power level, increase a receive power level, or both) and signal quality (e.g., reduced interference) in wireless communication systems. In some cases, a transmitter may use a beam management inference model to predict a future beam direction based on historical data and real-time measurements. To illustrate, a beam management inference model may be implemented using artificial intelligence (AI) and/or a trained machine learning (ML) model. “Intelligent system” denotes an infrastructure for training, testing, validating, knowledge updating, data integration, logic-based adaptation, parameter tuning, and/or deploying an inference algorithm; “inference model” denotes the deployed AI and/or trained ML model; and “inference phase” denotes the use of an inference model. In some cases, a beam management inference model may be trained to predict and/or select a beam configuration (e.g., optimal beam direction and power level), such as by selecting the beam configuration based at least in part on a current operating environment (e.g., a UE location, a UE movement pattern, and surrounding obstacles).

The use of a disaggregated network architecture may increase a complexity of using a beam management inference model relative to a monolithic base station. To illustrate, in a disaggregated architecture, functionality that is provided by a monolithic base station may be split into separate functional units in the disaggregated architecture, such as a central unit (CU) and a distributed unit (DU). The CU may manage higher-layer processing tasks such as radio resource control (RRC) and mobility management, while the DU may manage lower-layer tasks like signal processing and radio transmission. The separation of functionality may enable a CU to manage multiple DUs, allowing for more efficient resource allocation, such as dynamically distributing bandwidth and processing power based on real-time demand, and improving network performance by reducing latency and optimizing signal quality across various locations. Alternatively, or additionally, using partitioned functionality, a network operator may upgrade and maintain different parts of the network at a given time, leading to enhanced overall efficiency and reduced operational costs.

Beam management in a disaggregated network architecture, such as beam management through the use of a beam management inference model, may result in a discontinuity between one or more characteristics of training data used to generate a beam management inference model and one or more characteristics of an operating environment for a deployed beam management inference model. To illustrate, the separation of functionality into a CU and a DU may result in different layers of processing such that the CU may train a beam management inference model, and the DU may apply the beam management inference model in real-time based on current operating conditions. In some cases, the beam management inference model may be optimized or trained for particular operating conditions (e.g., specific layer 1 (L1) measurement conditions, specific layer 3 (L3) measurement conditions, or environmental factors such as building obstructions or weather conditions) such that deviations from the particular operating scenario in the deployment operating environment may result in reduced model accuracy or performance. Examples of reduced model accuracy or performance may include incorrect beam direction predictions or failure to adapt to sudden changes in the environment. Without knowledge of how the beam management inference model was generated, the DU may use a beam management inference model to predict beam configurations, resulting in suboptimal beam selection (e.g., suboptimal beam configurations), increased interference, or inefficient resource allocation.

Various aspects relate generally to beam management inference model coordination in a disaggregated network. Some aspects more specifically relate to coordinating interactions between a CU and a DU to ensure that beam management inference model usage (e.g., a current operating environment) is consistent with training (e.g., one or more operating configurations used to train the beam management inference model). In some aspects, a network node may transmit an indication of a training data configuration for collecting training data associated with the generation of a beam management inference model. Based at least in part on transmitting the indication of the training data configuration, the network node may receive the training data that is based on the training data configuration. The network node may generate the beam management inference model using the received training data. As at least part of deploying the beam management inference model, the network node may transmit the indication of the training data configuration for the training data used to generate the beam management inference model.

In some aspects, a network node may receive a beam management inference model along with an indication of a training data configuration associated with the model. The network node may derive an activation state for using the beam management inference model based at least in part on a current operating condition or one or more criteria indicated by the training data configuration. In some aspects, the current operating condition may be indicated by, or derived from, a measurement metric (e.g., an L1 measurement metric or an L3 measurement metric), detecting the occurrence of an event trigger, or both. Alternatively, or additionally, the network node may selectively apply the beam management inference model for beam management based on the derived activation state. As one example, the network node may compare the current operating condition to the criteria indicated by the training data configuration, such as by comparing a measurement metric to a measurement metric threshold indicated by the training data configuration. Based at least in part on the current operating condition satisfying the criteria, the network node may apply the beam management inference model. Alternatively, based at least in part on the current operating condition failing to satisfy the criteria or based otherwise, the network node may refrain from using the beam management inference model.

In some aspects, a network node may select one or more UEs for collecting training data associated with the generation of a beam management inference model. The network node may transmit an indication of a training data configuration to configure the one or more UEs for collecting the training data. Based at least in part on transmitting the indication of the training data configuration, the network node may receive the training data that is based on the training data configuration. The network node may generate the beam management inference model using the received training data. In some aspects, the network node may selectively apply the beam management inference model for beam management using an activation state that may be based at least in part on a current operating condition or one or more criteria indicated by the training data configuration.

Particular aspects of the subject matter described in this disclosure can be implemented to realize one or more of the following potential advantages. In some examples, by deploying a beam management inference model with an indication of a training data configuration (e.g., one or more conditions used to train or generate the beam management inference model), the described techniques can be used to ensure consistency between the usage of the beam management inference model and the conditions under which the beam management inference model was trained. Ensuring consistency may mitigate reduced accuracy or performance due to discrepancies between the training environment and the deployment environment. That is, ensuring the consistency may increase the accuracy of beam prediction, resulting in increased signal strength, reduced interference, and optimized resource allocation.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

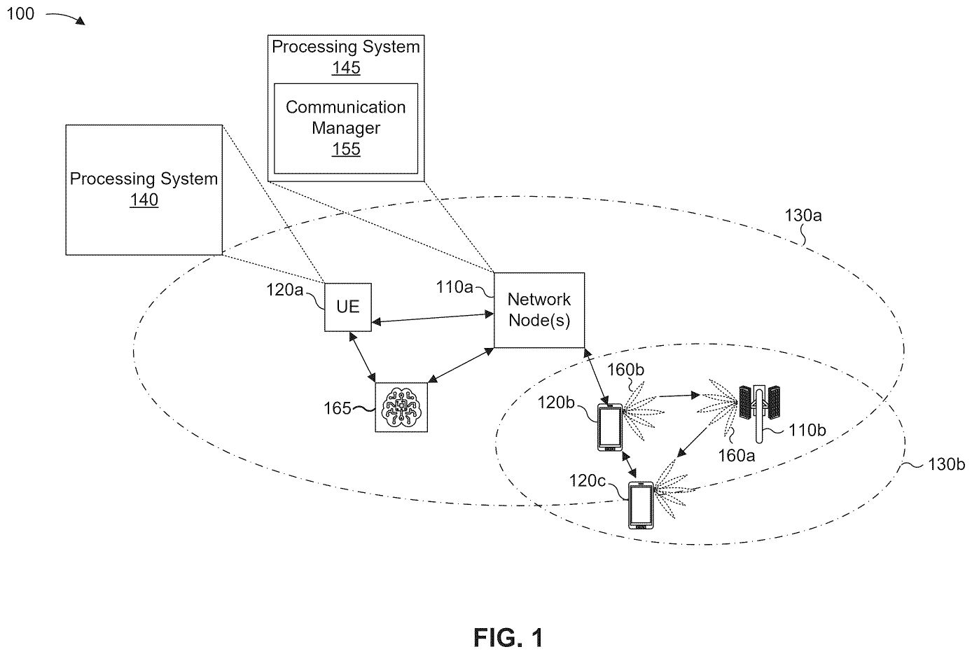

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more CUs, one or more DUs, and one or more radio units (RUs). A CU may host one or more higher layers, such as a RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, an L1-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. “MIMO communication” generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an AI program (for example, referred to herein as an “AI/ML model”), such as a program that includes an ML model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a network node (e.g., a network node 110) may include a communication manager 155. In some cases, based at least in part on the network node operating as a training network node (e.g., a CU), the communication manager 155 may transmit an indication of a training data configuration for collecting training data that is associated with generation of a beam management inference model; receive the training data that is based at least in part on the training data configuration; generate the beam management inference model using the training data; and transmit, as at least part of a deployment of the beam management inference model, the indication of the training data configuration.

In some cases, based at least in part on the network node operating as an inference network node (e.g., a DU), the communication manager 155 may receive a beam management inference model and an indication of a training data configuration that is associated with the beam management inference model; derive an activation state for using the beam management inference model based at least in part on at least one of: a current operating condition, or one or more criteria indicated by the training data configuration; and apply the beam management inference model for beam management selectively and based at least in part on the activation state. Additionally, or alternatively, the communication manager 155 may perform one or more other operations described herein.

In some cases, based at least in part on the network node operating as a training network node and an inference network node (e.g., a DU), the communication manager 155 may select one or more UEs for collecting training data that is associated with generation of a beam management inference model; transmit an indication of a training data configuration to configure the one or more UEs for collecting the training data; receive the training data, the training data being based at least in part on the training data configuration; and generate the beam management inference model using the training data. Additionally, or alternatively, the communication manager 155 may perform one or more other operations described herein.

In some cases, based at least in part on the network node operating as a training network node and an inference network node (e.g., a CU), the communication manager 155 may select one or more UEs for collecting training data that is associated with generation of a beam management inference model; transmit an indication of a training data configuration to configure the one or more UEs for collecting the training data; receive the training data, the training data being based at least in part on the training data configuration; generate the beam management inference model using the training data; and apply the beam management inference model for beam management selectively using an activation state, the activation state being based at least in part on at least one of: a current operating condition, or one or more criteria indicated by the training data configuration. Additionally, or alternatively, the communication manager 155 may perform one or more other operations described herein.

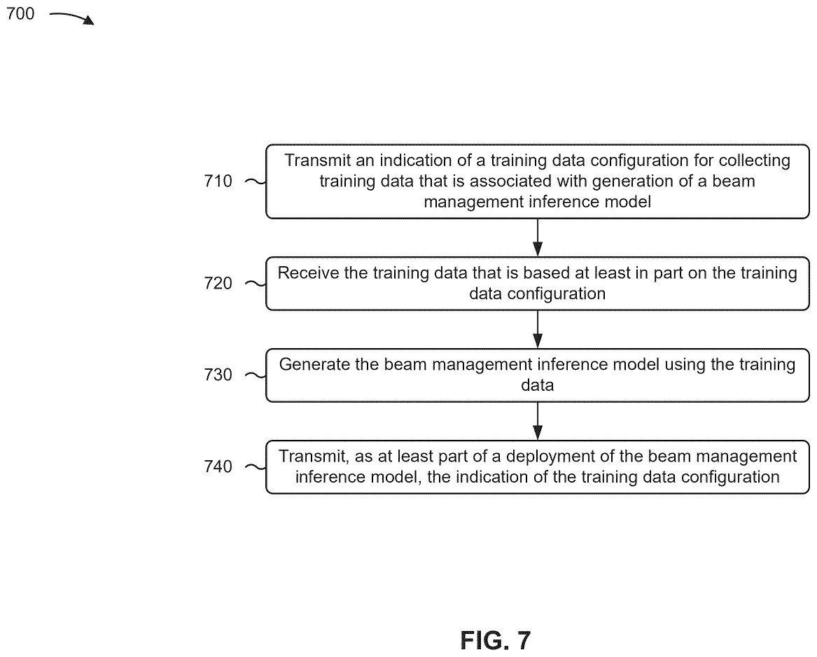

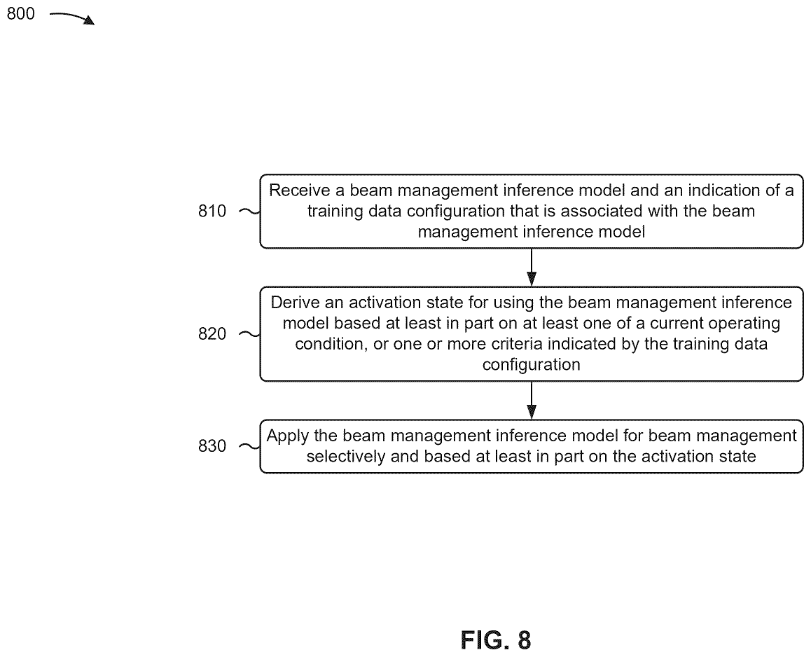

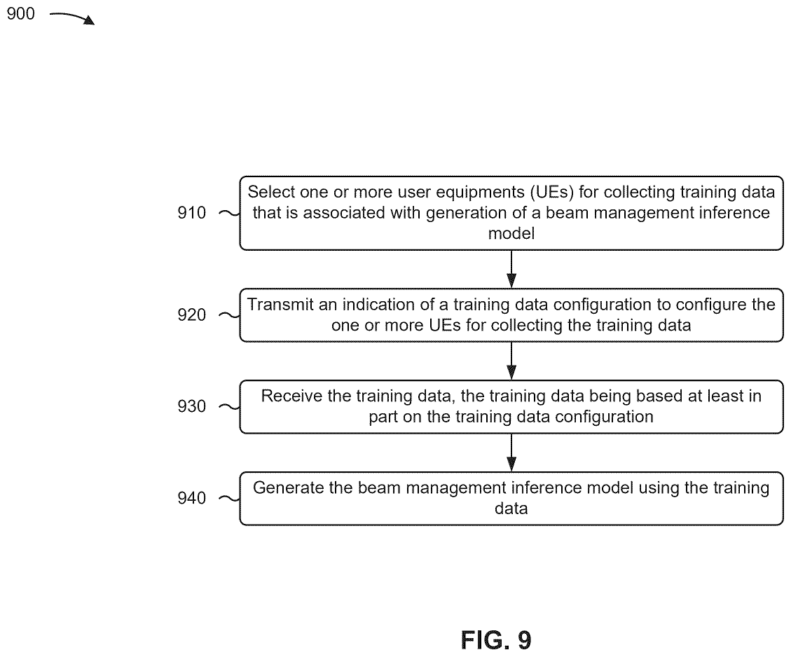

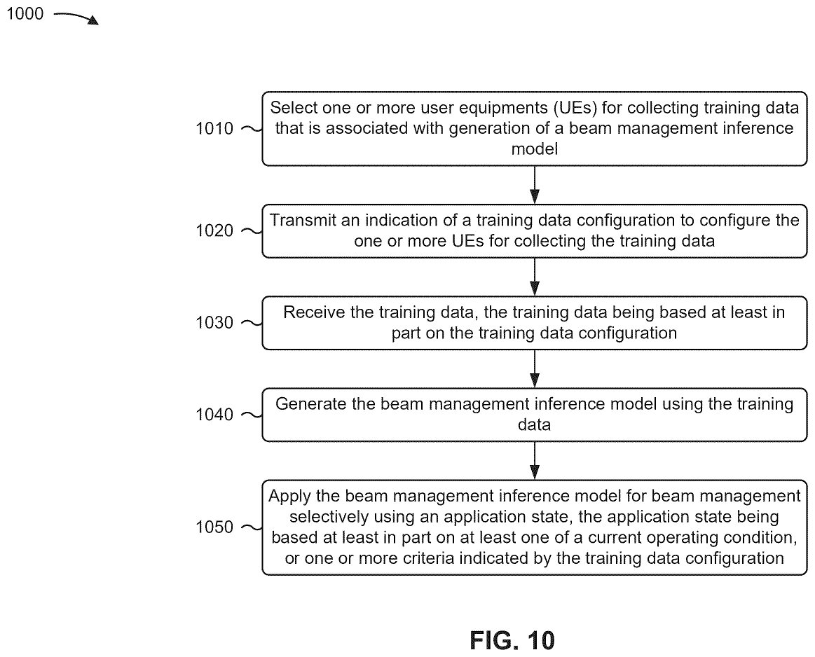

The network node 110, the processing system 145 of the network node 110, the UE 120, the processing system 140 of the UE 120, or any other component(s) of FIG. 1 may implement one or more techniques or perform one or more operations associated with beam management inference model coordination in a disaggregated network, as described in more detail elsewhere herein. For example, the processing system 145 of the network node 110, or the processing system 140 of the UE 120 may perform or direct operations of, for example, process 700 of FIG. 7, process 800 of FIG. 8, process 900 of FIG. 9, process 1000 of FIG. 10, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, process 900 of FIG. 9, process 1000 of FIG. 10, or other processes as described herein. In some examples, executing instructions may include running the instructions, converting the instructions, compiling the instructions, or interpreting the instructions, among other examples.

In some aspects, a network node (e.g., a network node 110) operates as a training network node (e.g., a CU), and includes means for transmitting an indication of a training data configuration for collecting training data that is associated with generation of a beam management inference model; means for receiving the training data that is based at least in part on the training data configuration; means for generating the beam management inference model using the training data; or means for transmitting, as at least part of a deployment of the beam management inference model, the indication of the training data configuration.

Alternatively, or additionally, the network node operates as an inference network node (e.g., a DU), and includes means for receiving a beam management inference model and an indication of a training data configuration that is associated with the beam management inference model; means for deriving an activation state for using the beam management inference model based at least in part on at least one of: a current operating condition, or one or more criteria indicated by the training data configuration; or means for applying the beam management inference model for beam management selectively and based at least in part on the activation state.

Alternatively, or additionally, the network node operates as a training network node and an inference network node (e.g., a DU), and includes means for selecting one or more UEs for collecting training data that is associated with generation of a beam management inference model; means for transmitting an indication of a training data configuration to configure the one or more UEs for collecting the training data; means for receiving the training data, the training data being based at least in part on the training data configuration; or means for generating the beam management inference model using the training data.

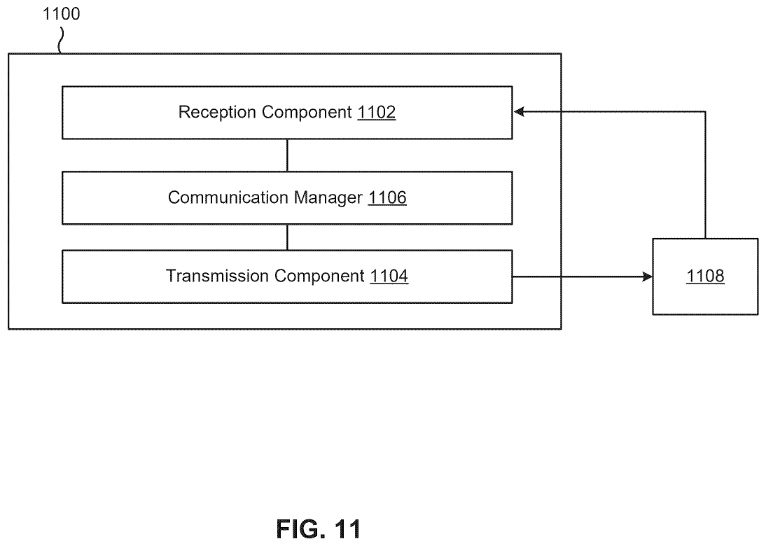

Alternatively, or additionally, the network node operates as a training network node and an inference network node (e.g., a CU), and includes means for selecting one or more UEs for collecting training data that is associated with generation of a beam management inference model; means for transmitting an indication of a training data configuration to configure the one or more UEs for collecting the training data; means for receiving the training data, the training data being based at least in part on the training data configuration; means for generating the beam management inference model using the training data; or means for applying the beam management inference model for beam management selectively using an activation state, the activation state being based at least in part on at least one of: a current operating condition, or one or more criteria indicated by the training data configuration. The means for the network node to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

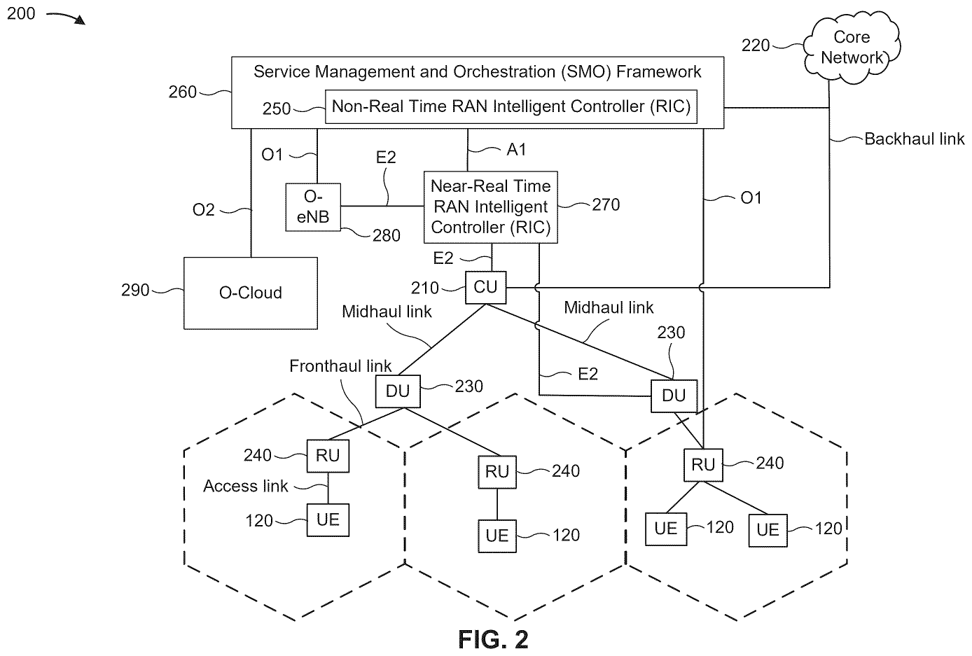

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium. In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270. In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

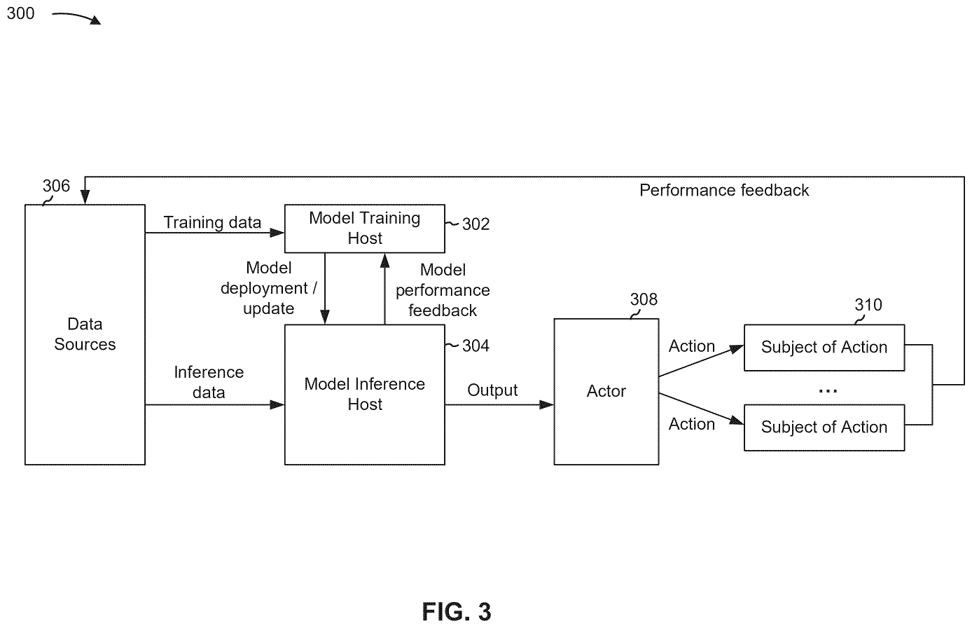

FIG. 3 is a diagram illustrating an example architecture 300 of a functional framework for radio access network (RAN) intelligence enabled by data collection. In some scenarios, the functional framework for RAN intelligence may be enabled by further enhancement of data collection through use cases or examples. For example, principles or algorithms for RAN intelligence enabled by AI/ML and the associated functional framework (e.g., the AI functionality or the input/output of the component for AI enabled optimization) have been utilized or studied to identify the benefits of AI enabled RAN through possible use cases (e.g., beam management, energy saving, load balancing, mobility management, or coverage optimization, among other examples). In one example, as shown by the architecture 300, a functional framework for RAN intelligence may include multiple logical entities, such as a model training host 302, a model inference host 304, data sources 306, and an actor 308.

The model inference host 304 may be configured to run an AI/ML model based on inference data provided by the data sources 306, and the model inference host 304 may produce an output (e.g., a prediction) with the inference data input to the actor 308. The actor 308 may be an element or an entity of a core network or a RAN. For example, the actor 308 may be a UE, a network node, base station (e.g., a gNB), a CU, a DU, or an RU, among other examples. In addition, the actor 308 may also depend on the type of tasks performed by the model inference host 304, type of inference data provided to the model inference host 304, or type of output produced by the model inference host 304. For example, if the output from the model inference host 304 is associated with beam management, then the actor 308 may be a UE, a DU or an RU. In other examples, if the output from the model inference host 304 is associated with Tx/Rx scheduling, then the actor 308 may be a CU or a DU.

After the actor 308 receives an output from the model inference host 304, the actor 308 may determine whether to act based on the output. For example, if the actor 308 is a DU or an RU and the output from the model inference host 304 is associated with beam management, the actor 308 may determine whether to change/modify a Tx/Rx beam based on the output. If the actor 308 determines to act based on the output, the actor 308 may indicate the action to at least one subject of action 310. For example, if the actor 308 determines to change/modify a Tx/Rx beam for a communication between the actor 308 and the subject of action 310 (e.g., a UE 120), then the actor 308 may transmit a beam (re-)configuration or a beam switching indication to the subject of action 310. The actor 308 may modify its Tx/Rx beam based on the beam (re-)configuration, such as switching to a new Tx/Rx beam or applying different parameters for a Tx/Rx beam, among other examples. As another example, the actor 308 may be a UE and the output from the model inference host 304 may be associated with beam management. For example, the output may be one or more predicted measurement values for one or more beams. The actor 308 (e.g., a UE) may determine that a measurement report (e.g., an L1 RSRP report) is to be transmitted to a network node 110.

The data sources 306 may also be configured for collecting data that is used as training data for training an ML model or as inference data for feeding an ML model inference operation. For example, the data sources 306 may collect data from one or more core network or RAN entities, which may include the subject of action 310, and provide the collected data to the model training host 302 for ML model training. For example, after a subject of action 310 (e.g., a UE 120) receives a beam configuration from the actor 308, the subject of action 310 may provide performance feedback associated with the beam configuration to the data sources 306, where the performance feedback may be used by the model training host 302 for monitoring or evaluating the ML model performance, such as whether the output (e.g., prediction) provided to the actor 308 is accurate. In some examples, if the output provided by the actor 308 is inaccurate (or the accuracy is below an accuracy threshold), then the model training host 302 may determine to modify or retrain the ML model used by the model inference host, such as via an ML model deployment/update.

“Beam management” refers to the process of directing and adjusting RF beams to optimize signal strength (e.g., increase a transmit power level, increase a receive power level, or both) and signal quality (e.g., reduced interference) in wireless communication systems. In some cases, a transmitter may use a beam management inference model to predict a future beam direction based on historical data and real-time measurements. To illustrate, a beam management inference model may be implemented using AI and/or a trained machine learning ML model. “Intelligent system” denotes an infrastructure for training, testing, validating, knowledge updating, data integration, logic-based adaptation, parameter tuning, and/or deploying an inference algorithm; “inference model” denotes the deployed AI and/or trained ML model; and “inference phase” denotes the use of an inference model. In some cases, a beam management inference model may be trained to predict and/or select a beam configuration (e.g., optimal beam direction and power level), such as by selecting the beam configuration based at least in part on a current operating environment (e.g., a UE location, a UE movement pattern, and surrounding obstacles).

The use of a disaggregated network architecture may increase a complexity of using a beam management inference model relative to a monolithic base station. To illustrate, in a disaggregated architecture, functionality that is provided by a monolithic base station may be split into separate functional units in the disaggregated architecture, such as a CU and a DU. The CU may manage higher-layer processing tasks such as RRC and mobility management, while the DU may manage lower-layer tasks like signal processing and radio transmission. The separation of functionality may enable a CU to manage multiple DUs, allowing for more efficient resource allocation, such as dynamically distributing bandwidth and processing power based on real-time demand, and improving network performance by reducing latency and optimizing signal quality across various locations. Alternatively, or additionally, using partitioned functionality, a network operator may upgrade and maintain different parts of the network at a given time, leading to enhanced overall efficiency and reduced operational costs.

Lifecycle management (LCM) of beam management inference models involves determining when to activate or deactivate data collection and when to deploy or retire specific models to ensure optimal performance and resource efficiency. For instance, a network node may deactivate data collection during periods of low network activity to conserve resources. Additionally, the lifecycle of a trained model may include stages such as model validation, deployment, monitoring, and eventual deactivation or replacement with an updated model. The decision to deactivate a model or data collection may be based on predefined criteria such as a significant change in network conditions, the introduction of new UEs, or the availability of an improved model. This ensures that the network continues to operate efficiently and effectively while utilizing the most accurate and relevant beam management inference models.

Beam management in a disaggregated network architecture, such as beam management through the use of a beam management inference model, may result in a discontinuity between one or more characteristics of training data used to generate a beam management inference model and one or more characteristics of an operating environment for a deployed beam management inference model. To illustrate, the separation of functionality into a CU and a DU may result in different layers of processing such that the CU may train a beam management inference model, and the DU may apply the beam management inference model in real-time based on current operating conditions. In some cases, the beam management inference model may be optimized or trained for particular operating conditions (e.g., specific L1 measurement conditions, specific L3 measurement conditions, or environmental factors such as building obstructions or weather conditions) such that deviations from the particular operating scenario in the deployment operating environment may result in reduced model accuracy or performance. Examples of reduced model accuracy or performance may include incorrect beam direction predictions or failure to adapt to sudden changes in the environment. Without knowledge of how the beam management inference model was generated, the DU may use a beam management inference model to predict beam configurations, resulting in suboptimal beam selection (e.g., suboptimal beam configurations), increased interference, or inefficient resource allocation.

Various aspects relate generally to beam management inference model coordination in a disaggregated network. Some aspects more specifically relate to coordinating interactions between a CU and a DU to ensure that beam management inference model usage (e.g., a current operating environment) is consistent with training (e.g., one or more operating configurations used to train the beam management inference model). In some aspects, a network node may transmit an indication of a training data configuration for collecting training data associated with the generation of a beam management inference model. Based at least in part on transmitting the indication of the training data configuration, the network node may receive the training data that is based on the training data configuration. The network node may generate the beam management inference model using the received training data. As at least part of deploying the beam management inference model, the network node may transmit the indication of the training data configuration for the training data used to generate the beam management inference model.

In some aspects, a network node may receive a beam management inference model along with an indication of a training data configuration associated with the model. The network node may derive an activation state for using the beam management inference model based at least in part on a current operating condition or one or more criteria indicated by the training data configuration. In some aspects, the current operating condition may be indicated by, or derived from, a measurement metric (e.g., an L1 measurement metric or an L3 measurement metric), detecting the occurrence of an event trigger, or both. Alternatively, or additionally, the network node may selectively apply the beam management inference model for beam management based on the derived activation state. As one example, the network node may compare the current operating condition to the criteria indicated by the training data configuration, such as by comparing a measurement metric to a measurement threshold indicated by the training data configuration. Based at least in part on the current operating condition satisfying the criteria, the network node may apply the beam management inference model. Alternatively, based at least in part on the current operating condition failing to satisfy the criteria or based otherwise, the network node may refrain from using the beam management inference model.

In some aspects, a network node may select one or more UEs for collecting training data associated with the generation of a beam management inference model. The network node may transmit an indication of a training data configuration to configure the one or more UEs for collecting the training data. Based at least in part on transmitting the indication of the training data configuration, the network node may receive the training data that is based on the training data configuration. The network node may generate the beam management inference model using the received training data. In some aspects, the network node may selectively apply the beam management inference model for beam management using an activation state (e.g., an activation state for using the beam management inference model) that may be based at least in part on a current operating condition or one or more criteria indicated by the training data configuration.

Particular aspects of the subject matter described in this disclosure can be implemented to realize one or more of the following potential advantages. In some examples, by deploying a beam management inference model with an indication of a training data configuration (e.g., one or more conditions used to train or generate the beam management inference model), the described techniques can be used to ensure consistency between the usage of the beam management inference model and the conditions under which the beam management inference model was trained. Ensuring consistency may mitigate reduced accuracy or performance due to discrepancies between the training environment and the deployment environment. That is, ensuring the consistency may increase the accuracy of beam prediction, resulting in increased signal strength, reduced interference, and optimized resource allocation.

As indicated above, FIG. 3 is provided as an example. Other examples may differ from what is described with regard to FIG. 3.

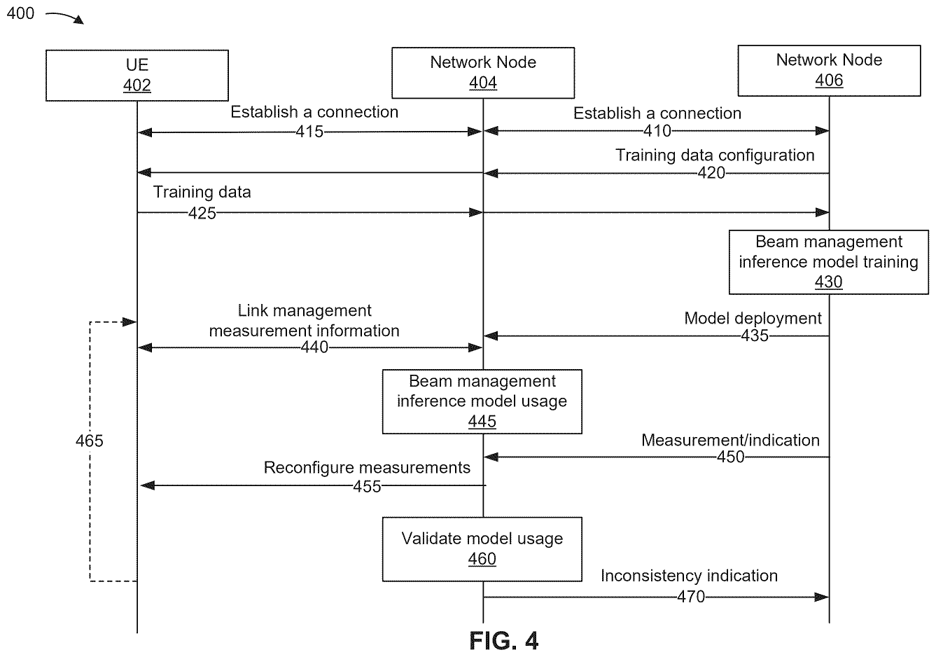

FIG. 4 is a diagram illustrating an example 400 of a wireless communication process between a UE 402 (e.g., the UE 120), a network node 404 (e.g., a first network node 110), and a network node 406 (a second network node 110). In some aspects, the network node 404 is a first node of a disaggregated network (e.g., a DU) and the network node 406 is a second node of a disaggregated network (e.g., a CU). The wireless communication process described with regard to the example 400 may be used to coordinate a beam management inference model being trained at one disaggregated network node (e.g., the CU) and deployed for usage at another disaggregated network node (e.g., the DU). A training network node may be a variety of network nodes or functions, such as a gNB-DU, a gNB-CU, a core network function (NF), an Operations, Administration, and Maintenance (OAM), a Service Management and Orchestration (SMO), or a RAN Intelligent Controller (RIC).

As shown by reference number 410, a network node 404 may establish a first connection with a network node 406. To illustrate, the network node 404 may be a DU of a disaggregated network and the network node 406 may be a CU of the disaggregated network. In some cases, the network node 404 and the network node 406 may establish the first connection by utilizing the F1 interface. In some aspects, establishing the first connection may include establishing signaling pathways and configuring communication protocols between the first network node 404 and the second network node 406. The process of establishing this connection may include multiple steps. For instance, the network node 404 may send a connection request to the network node 406, and the connection request may include information about network node 404 capabilities, services supported by the network node 404, or both. Based at least in part on receiving the connection request, the network node 406 may authenticate the network node 404 and verify one or more credentials of the network node 404 to ensure secure communication. The network node 406 may configure the network node 404 with one or more parameters, such as any combination of an Internet protocol (IP) address, a port number, or a security key, to establish a secure signaling connection (e.g., an Internet protocol security (IPsec) connection) and ensure the integrity and confidentiality of the exchanged between the nodes.

As shown by reference number 415, the network node 404 may establish a second connection with a UE 402. To illustrate, the UE 402 may power up in a cell coverage area provided by the network node 404, and the UE 402 and the network node 404 may perform one or more procedures (e.g., a random access channel (RACH) procedure and/or an RRC procedure) to establish a wireless connection. As another example, the UE 402 may move into the cell coverage area provided by the network node 404 and may perform a handover from a source network node (e.g., another network node 110) to the network node 404. Alternatively, or additionally, the network node 404 and the UE 402 may communicate via the connection based at least in part on any combination of Layer 1 signaling (e.g., DCI, UCI, or both), Layer 2 signaling (e.g., a MAC-CE), and/or Layer 3 signaling (e.g., RRC signaling). To illustrate, the network node 404 may request, via RRC signaling, UE capability information and/or the UE 402 may transmit, via RRC signaling, the UE capability information. As part of communicating via the connection, the network node 404 may transmit configuration information via Layer 3 signaling (e.g., RRC signaling), and activate and/or deactivate a particular configuration via Layer 2 signaling (e.g., a MAC-CE) and/or Layer 1signaling (e.g., DCI). To illustrate, the network node 404 may transmit the configuration information via Layer 3 signaling at a first point in time associated with the UE being tolerant of communication delays, and the network node 404 may transmit an activation of the configuration via Layer 2 signaling and/or Layer 1 signaling at a second point in time associated with the UE 402 being intolerant to communication delays.

As shown by reference number 420, the network node 406 may transmit, and the network node 404 may receive, an indication of a training data configuration. For example, the network node 406 may transmit the training data configuration using the F1 interface. The training data configuration may include one or more parameters associated with the collection of training data for generating a beam management inference model. Examples of information that may be included in the training data configuration include one or more measurement types (e.g., an L1 measurement, such as RSRP or SINR), one or more measurement metric thresholds (e.g., an L1 measurement metric threshold, an L3 measurement metric threshold, a received signal power quality threshold) one or more beam identifiers, a measurement logging interval, one or more event-triggered logging configurations (e.g., a radio condition-based event, such as an L3 serving cell measurement threshold, a beam-based event, an L1 beam level measurements, or any combination), a reporting configuration, or a logging configuration. Examples of an L1 measurement metric threshold may include an L1-RSRP measurement threshold and L1-SINR measurement threshold. Examples of an L3-measurement metric threshold may include serving cell RSRP threshold and a serving cell SINR threshold.

In some cases, the network node 406 may request that the network node 404 configure the UE 402 using the training data configuration, such as by requesting that the network node 404 configure one or more L1 measurement metrics at the UE using the training data configuration. Alternatively, or additionally, the network node 406 may indicate, to the network node 404, any combination of an event trigger configuration (e.g., an L1 measurement threshold, a beam-based event, or both) to use in configuring one or more L1 measurement metrics at the UE 402. In some cases, the network node 406 may request that the network node 404 configure the UE 402 to perform periodic measurement reporting (e.g., periodic L1 measurement reporting), on-demand measurement reporting, or event triggered measurement reporting. Alternatively, or additionally, the network node 406 may request that the network node 404 configure the UE 402 to perform periodic measurement logging, event triggered measurement logging, or on-demand measurement logging.

The training data configuration may indicate a configuration to use for generating a measurement metric (e.g., as training data), such as by specifying a type of measurement (e.g., RSRP, SINR), a frequency for generating a measurement metric, a beam to use for generating the measurement metric (e.g., by specifying a beam identifier), or one or more conditions to use for triggering the generation of a measurement metric (e.g., during specific time intervals or when certain events occur). Alternatively, or additionally, the training data configuration may include a measurement logging configuration (e.g., an event for logging a measurement metric, or a logging interval), a measurement log reporting configuration (e.g., on-demand reporting of logged measurements, periodic reporting intervals, or conditions for triggering the reporting of logged data), or any combination thereof. For example, the training data configuration may indicate to log one or more beam identifiers and a respective signal strength measurement metric for each beam identifier at 100 millisecond (msec) intervals during a time window in which an amount of data traffic satisfies a peak traffic threshold.

In some cases, the training data configuration may indicate one or more criteria that may be used to determine one or more conditions that trigger collecting training data (e.g., one or more measurement metrics). The inclusion of measurement metric criteria may ensure that the collected training data is relevant and useful for generating and optimizing the beam management inference model. In some cases, the measurement metric criteria may be associated with various aspects of network performance (e.g., signal strength or signal quality) and may specify events that trigger data logging, trigger measurement reporting, or both. Some non-limiting examples of criteria include an L1 measurement threshold (e.g., an RSRP threshold value or an SINR threshold value), an L3 measurement threshold (e.g., a serving cell measurement threshold), an event trigger threshold (e.g., one or more conditions under which measurements should be logged), one or more beam-related events (e.g., when a particular beam meets certain criteria such as becoming the top-ranked beam or if the UE 402 is attached to a given set of beams), or one or more specific beam identifiers (e.g., unique identifiers for beams that are to be monitored or measured, such as beam IDs associated with particular directions or sectors). The network node 406 may select a training data configuration based at least in part on input from the network node 404. As one example, the network node 404 indicate a proposed measurement configuration to the network node 406 via the F1 interface. The network node 404 may send to the propose measurement configuration to the network node 406 autonomously or based at least in part on a request. For instance, in some aspects, the network node 406 may send a request for an L1 measurement configuration to use for configuring training data and, subsequently, a beam management inference module. The proposed measurement configuration may include any combination of a set of proposed beams, an L3 measurement metric threshold, an L1 measurement metric threshold, a periodicity, or a beam-based event. Examples of L3 measurement metric thresholds include serving cell RSRP and SINR thresholds, while L1 measurement metric thresholds may encompass RSRP and SINR values specific to individual beams. Alternatively, or additionally, the proposed measurement configuration may indicate a periodicity, such as a logging periodicity. In some cases, the network node 404 may indicate one or more proposed beams to the network node 406 that are most relevant (e.g., out of a set of proposed beams) to a current operating condition or location of the UE 402, and the network node 406 may select the training data configuration based at least in part on the proposed measurement configuration (e.g., the proposed beams). The proposed measurement configuration may include one or more beam-based events, such as when a specific beam becomes a top-ranked beam based on signal quality or when the signal strength of a beam exceeds a predefined threshold. By indicating a proposed measurement configuration based at least in part on a current operating condition, the network node 404 may increase a probability that the collected training data, and a beam management inference model trained on the collected training data, is relevant to the UE 402.

In some aspects, the network node 406 may select one or more UEs to perform training data collection. For example, the network node 406 may select the UE(s) for training data collection based at least in part on selection criteria, such as any combination of a UE location, a UE mobility pattern, and or a signal quality. Alternatively, or additionally, the selection criteria may be based at least in part on one or more criteria of the beam management inference model, such as a diversity of beam angles, a frequency of beam switches, or historical performance metrics of the beams.

As shown by FIG. 4, based at least in part on receiving the training data configuration, the network node 404 may transmit, and the UE 402 may receive, at least a portion of the training data configuration. For example, the network node 404 may forward the parameters of the training data configuration to the UE 402 using one or more RRC messages, such as an RRC reconfiguration message, an RRC measurement configuration message, an RRC measurement report message, or any combination thereof. To illustrate, the network node 404 may forward one or more measurement logging parameters, such as a type of measurement to be logged (e.g., RSRP, SINR), a logging interval, one or more conditions for event-triggered logging (e.g., L3 serving cell measurement thresholds, beam-based events, L1 beam level measurements), or any combination thereof, to the UE 402 using an RRC reconfiguration message. Alternatively, or additionally, the network node 404 may forward specific measurement objects, reporting criteria, and reporting intervals to the UE 402 using an RRC measurement configuration message. In some cases, the network node 404 may forward the request for on-demand reporting of logged measurements to the UE 402 using an RRC measurement report message.

In some aspects, the network node 404 may configure the UE 402 to use one or more beams (e.g., a set of beams) for generating an L1 measurement metric using one or more beams indicated by the network node 406. As an example, the training data configuration from the network node 406 may indicate a set of beams, and the network node 404 may configure the UE 402 using the set of beams.

Alternatively, or additionally, the network node 406 may transmit a measurement configuration or a measurement logging configuration directly to the UE 402 without assistance from network node 404. For example, network node 406 may transmit an RRC reconfiguration message directly to the UE 402. In some cases, the network node 406 may use dynamic signaling (e.g., a MAC-CE or DCI) to adjust a measurement interval or event trigger-based logging. Bypassing the network node 404 enables the network node 406 to quickly adapt to changing network conditions and optimize beam management by providing the UE 402 with the updated measurement configurations or updated logging configurations promptly.

As shown by reference number 425, the UE 402 may transmit, and the network node 404 may receive, training data. Alternatively, or additionally, the network node 404 may transmit, and the network node 406 may receive, the training data. To illustrate, the UE 402 may transmit, and the network node 404 may receive, the training data in RRC signaling. The network node 404 may transmit, and the network node 406 may receive, the training data using an F1 interface. In some cases, the network node 404 may receive one or more L1 measurement metrics directly from the UE 402 via PUCCH, and may forward the L1 measurement metric(s) to the network node 406 via the F1 interface. Alternatively, or additionally, the network node 406 may detect an L3 event trigger, and may send one or more L3 measurement reports to the network node 404 using the F1 interface. Based at least in part on detecting an L3 threshold has been reached, the network node 404 may configure one or more L1 measurement metrics at the UE 402, and may send one or more L1 measurement metrics to the network node 406 as training data. The network node 404 may configure the UE 402 to use one or more beams (e.g., a set of beams) for generating an L1 measurement metric using one or more beams indicated by the network node 406.

In some aspects, the UE 402 may collect and log, as the training data, measurement information as specified by the training data configuration. To illustrate, the training data may include various types of measurements (e.g., an L1-RSRP measurement metric or an L1-RSRQ measurement metric), one or more beam identifiers, signal quality indicators (e.g., SINR or CQI), or any combination thereof. The training data may also include other relevant metrics such as an L3 serving cell measurement metric, beam-based events, or an L1 beam level measurement metric. The inclusion of detailed beam metrics, signal strength measurements, and quality indicators may enable a training node (e.g., the network node 406) to optimize the generation of the beam management inference model to a particular operating environment or particular operating scenario that may be identified or derived from the training data.

For clarity, FIG. 4 illustrates the UE 402 transmitting training data prior to the network node performing beam management inference model training, but other examples may include the UE 402 transmitting the training data at other times than described with regard to the example 400. For example, the UE 402 may transmit the training data on-demand, periodically, or based on specific event triggers. To illustrate, the UE 402 may receive a request for the training data and may transmit the training data using RRC signaling, such as an RRC measurement report message. As an example, the network node 406 may send a UEInformationRequest message to the UE 402 to request the logged measurements, and the UE 402 may transmit a UEInformationResponse message to provide the requested logged measurements to the network node 406.

As another example, the UE 402 may be configured to send the training data at predefined intervals and may transmit the training data using periodic RRC measurement report messages. In some cases, the UE 402 may transmit the training data based at least in part on detecting the occurrence of one or more conditions (e.g., as specified in the training data configuration, such as a criterion or event trigger). Example conditions may include specific thresholds for signal strength or quality, such as an L1-RSRP threshold or an SINR threshold, or events such as a beam becoming the top-ranked beam. Configuring how or when the UE 402 transmits training data may ensure that the network node 406 receives (e.g., by way of the network node 404) timely and relevant training data for generating and optimizing the beam management inference model to increase an accuracy of a beam prediction generated by the beam management inference model.

Alternatively, or additionally, while the example 400 includes the network node 404 sending the network node 406 measurement metrics from the UE 402, other examples may include different configurations. To illustrate, the network node 404 may request one or more L3 measurement metrics from the network node 406 based at least in part on detecting an occurrence of a measurement request event trigger (e.g., an event that indicates to request one or more measurement metrics), and the network node 406 may forward the L3 measurement(s) to the network node 404 using the F1 interface. In some cases, the network node 404 may use the L3 measurement metrics to determine whether to apply or use the beam management inference model as described below with regard to reference number 445. Alternatively, or additionally, the network node 404 may request the L3 measurement metrics based at least in part on detecting an occurrence of a measurement request event trigger, such as an L1 measurement metric event trigger that indicates to request the L3 measurement metric(s).

As shown by reference number 430, the network node 406 may perform beam management inference model training. The network node 406 may use historical data, past measurement results associated with the training data configuration, or both, to train a beam management inference model based on the collected training data. As one example, the network node 406 may train the beam management inference model in a similar manner as described regard to FIG. 3. The historical data, past measurement results, or both, may include various types of measurements (e.g., L1-RSRP or L1-RSRQ beam identifiers, or signal quality indicators (e.g., SINR, CQI)). Alternatively, or additionally, the network node 406 may use training data obtained from the UE 402 to train the beam management inference model.

As shown by reference number 435, the network node 406 may deploy the trained beam management inference model, such as by deploying the beam management inference model to the network node 404. As one example, deploying the beam management inference model may include installing the trained beam management inference model on the network node 404 to enable real-time beam management. Additionally, or alternatively, deploying the trained model may include transferring the trained model from network node 406 to network node 404 for deployment within the network.

In some aspects, as at least part of deploying the beam management inference model, the network node 406 may transmit, and the network node 404 may receive, an indication of at least a portion of the training data configuration described with regard to reference number 415. The indication of at least the portion of the training data configuration may enable the network node 404 to ensure that the application of the beam management inference model is consistent or within the operating parameters used to train or generate the beam management inference model, such as specific L1-RSRP thresholds, L1-SINR thresholds, periodic measurement intervals (e.g., every 100 milliseconds), event-triggered conditions (e.g., beam becoming the top-ranked beam), event-based L1 measurement metrics, specific beam identifiers used for logging measurement metrics, or any combination thereof. For instance, the training data configuration may specify that the model was trained using periodic L1-RSRP measurements logged every 100 milliseconds or event-triggered logging based on beam becoming the top-ranked beam. The network node 404 may use the indicated training data configuration information to apply the beam management inference model in a commensurate operating environment as a training operating environment, or detect a deviation in the current operating environment from the training operating environment, to ensure that a current operational environment of the beam management inference model is commensurate with the training operating environment. To illustrate, the network node 404 may validate that a current measurement metric is within a threshold of a training data measurement metric to ensure that the network node 404 applies or uses the beam management inference model in accordance with a training operating environment. The ability to validate the usage of a beam management inference model may mitigate an inaccurate beam prediction.

As shown by reference number 440, the UE 402 may transmit, and the network node 404 may receive, link management measurement reporting information (e.g., a measurement metric, a beam identifier, or both). Alternatively, or additionally, the network node 404 may transmit, and the UE 402 may receive, link management measurement configuration information (e.g., specific measurement types to be logged, logging intervals, or event-triggered logging conditions). In some aspects, the link management measurement configuration information and the link management measurement reporting information are separate from training data and may be part of link management operations. That is, the link management measurement configuration and link management measurement reporting may be used for maintaining and optimizing a link quality (e.g., reduced interference, increased signa power, or reduced data transfer latency) between the UE and the network node 404. In some cases, the network node 404 may use link management measurement metric(s) as input to the beam management inference model.

As an example of link management, the network node 404 may send an RRC measurement configuration message to the UE 402 specifying one or more types of measurement metrics to report for link management (e.g., RSRP, SINR). The RRC measurement configuration message may include details such as the specific measurement types to be logged, the logging intervals, and any event-triggered logging conditions. For example, the network node 404 may configure the UE 402 to log RSRP measurements every 100 milliseconds or to log measurements when a specific beam becomes the top-ranked beam. The UE 402 may transmit the requested link management measurement data, such as by transmitting one or more beam identifiers, one or more signal quality indicators, or a combination thereof, such as by transmitting an RRC measurement report message. The network node 404 may process the received link management measurement data and compute one or more decisions regarding link management, such as a transmission parameter adjustment, beam selection, or handover triggering. In some cases, the network node 404 may forward at least a portion of the measurement data to the network node 406, such as by using the F1 interface.

As shown by reference number 445, the network node 404 may use the beam management inference model for link management. For example, the network node 404 may use one or more link management measurement reports from the UE 402 (e.g., a measurement report that is not training data) as input to the beam management inference model to generate any combination of a beam prediction (e.g., a prediction of a future beam to use for communicating with the UE 402), transmit power levels, or a beam configuration (e.g., width, direction, or an angle of departure). The use of a beam management inference model may enable the network node 404 to dynamically adjust beam parameters in a manner that increases signal quality and reduces interferences, resulting in a reliable connection with the UE 402.

In some cases, the network node 404 may dynamically determine whether to use the beam management inference model for link management. For instance, the network node 404 may request one or more L3 measurement metrics from the network node 406, and the network node 406 may forward the L3 measurement(s) to the network node 404 using the F1 interface. The network node 404 may analyze the L3 measurement metrics to determine whether to apply or use the beam management inference model. For example, the network node 404 may compare a current L3 RSRP measurement metric to a predefined threshold and determine to use the beam management inference model based at least in part on the L3 RSRP measurement metric satisfying a strong signal threshold. Alternatively, the network node 406 may transmit an activation state to the network node 404, where the activation state indicates whether to enable or start using the beam management inference model (e.g., an enabled activation state) or whether to disable or stop using the beam management inference model (e.g., a disabled activation state). The network node 406 may derive the activation state based at least in part on the L3 measurement metric(s) at the network node 406. The network node 406 may transmit the activation state based at least in part on receiving a request from the network node 404 (e.g. a request to receive an indication of an activation state) or autonomously.

As shown by reference number 450, the network node 406 may transmit, and the network node 404 may receive, a measurement metric or an indication of a specific condition. For example, the network node 406 may transmit an L3 measurement metric (e.g., serving cell measurements) or an indication that a certain threshold or event has been met. The network node 404 may use the measurement metric or specific condition to adjust a beam configuration or a transmission parameter.

As shown by reference number 455, the network node 404 may transmit, and the UE 402 may receive, an indication of a measurement reconfiguration. For example, the network node 404 may adjust one or more measurement parameters, one or more logging configurations, or any combination thereof. To illustrate, the network node 404 may adjust a logging interval to increase a frequency of measurement reporting, and obtain more granular data for analysis. Alternatively, or additionally, the network node 404 may adjust an event-triggered logging condition to achieve more accurate detection of specific network events, such as beam failures or significant changes in signal quality. Adjusting measurement parameter(s) or logging parameter(s) may ensuring that the data collected is both relevant and useful for optimizing the beam management inference model.

As shown by reference number 460, the network node 404 may validate the detect beam management inference model usage. That is, the network node 404 may monitor for inconsistencies (e.g., between a current operating environment and a training operating environment), such as by monitoring the performance of the beam management inference model over time. For example, the network node 404 may evaluate a predicted beam configuration against real-time measurement data to identify when the predicted beam configurations do not align with the actual performance metrics, such as by monitoring an RSRP metric, an SINR metric, monitoring for a beam failure report (e.g., from the UE 402), or monitoring for a beam switch indication (e.g., from the UE 402). As one example, an unexpected drop in the RSRP metric may indicate that the predicted beam configuration generated by the beam management inference model is not an optimal beam configuration, and a significant change (e.g., a change that satisfies a change threshold) in the SINR metric may indicate increased interference or suboptimal beamforming by the predicted beam configuration.

In some aspects, the network node 404 may analyze link management measurement information from the UE 402, to validate beam management inference model usage, or to identify a deviation (e.g., a deviation that satisfies a deviation threshold) from a training operating environment and a current operating environment. For instance, the network mode 404 may analyze whether a current measurement metric deviates from a training measurement metric by at least a threshold value. In some aspects, the network node 404 may compare one or more current operating conditions, one or more current measurement results, or any combination thereof, with one or more training operating conditions, one or more training thresholds, or any combination thereof, associated with the beam management inference model being used by the network node 404. Performing the comparison may enable the network node 404 to identify an inconsistency that may reduce an accuracy or a beam prediction by the beam management inference model. Alternatively, or additionally, the network node 404 may compute a performance metric for the beam management inference model, such as a mean squared error (MSE) accuracy metric or an F1 score (F1 being a label).

As shown by reference number 465, the UE 402, the network node 404, and the network node 406 may iteratively exchange link management measurement reporting information, use the beam management inference model for link management, use measurement metrics or indications from the network node 406 to refine a transmission configuration, and validate beam management model usage. For instance, the UE 402 may iteratively transmit link management measurement reports to the network node 404 (as described with regard to reference number 440), the network node 404 may iteratively use these reports as input to the beam management inference model to generate beam predictions and adjust beam parameters (as described with regard to reference number 445), the network node 406 may iteratively transmit additional measurement metrics or indications to the network node 404 (as described with regard to reference number 450), and the network node 404 may iteratively validate beam management inference model usage (as described with regard to reference number 455).

As shown by reference number 470, the network node 404 may transmit, and the network node 406 may receive, an inconsistency indication, an accuracy metric for the beam management inference model, or both. For example, the network node 404 may transmit the inconsistency indication based at least in part of the validation performed as described with regard to reference number 460. That is, the network node 404 may transmit the inconsistency indication based at least in part on determining that the beam management inference model is invalid for current operating conditions (e.g., current operating conditions are not commensurate with training operating conditions). Alternatively, or additionally, the network node 404 may forward a performance metric associated with the beam management inference model, such as an MSE accuracy metric or an F1 score. While the example 400 includes the network node 404 notifying the network node 406 of a detected inconsistency, other examples may not include the network node 404 notifying the network node 406 of a detected inconsistency.

Alternative or additional steps relative to the wireless communication process described above may be included in example 400 to ensure consistency between the generation of a beam management inference model at one network node, and the application of the beam management inference model at another network node. To illustrate, the network node 404 may request that the network node 406 apply or use the beam management inference model to generate a beam prediction. Alternatively, or additionally, the network node 404 may send one or more L1 measurement metrics to the network node 406 using the F1 interface. In some cases, the network node 404 may send the L1 measurement metric(s) to the network node 406 based at least in part on receiving a request for the L1 measurement metric(s) from the network node 406 to send L1 measurement metrics of the UE 402. Based at least in part on receiving the L1 measurement(s), the network node 406 may determine whether to use the beam management inference model to generate a beam prediction for communicating with the UE 402. For instance, the network node 406 may determine not to use the beam management inference model based at least in part on the L1 measurement metric(s) indicating suboptimal conditions (e.g., low signal strength, high interference levels, or poor signal-to-noise ratio (SNR)). Alternatively, the network node 406 may determine to use the beam management inference model based at least in part on detecting an L1 measurement event trigger using the L1 measurement metric(s) (e.g., a change in signal quality that satisfies a change threshold). The network node 406 may generate and send beam prediction information to the network node 404 using the L1 measurement metric(s), such as, by way of example and not of limitation, the top K beams (e.g., the K beams with the highest signal power level) to use out of a set of beams, a predicted RSRP of the K beams, a predicted RSRQ of the K beams, or a predicted SINR of the K beams, to use in configuring the UE 402.

As another example, the network node 404 may request a beam prediction from the network node 406 by providing the L1 measurement metric(s) to the network node 406, and the network node 406 may use L3 measurement metric(s) to determine whether to use the beam management inference module to generate the beam prediction. As one example, the network node 406 may evaluate a signal quality or may detect a change (e.g., a change that satisfies a change threshold) in the network conditions using the L3 measurement metric(s). Based at least in part on determining to use the beam management inference module, the network node 406 may generate and send beam prediction information (e.g., top K beams, RSRP/Q, SINR of beams) to the network node 404 in a similar manner as described above.

In some cases, the network node 406 may monitor for an occurrence of a measurement report event trigger (e.g., a change in a signal quality that satisfies a change threshold) using one or more L3 measurement metrics associated with the UE 402. Based at least in part on detecting the measurement report event trigger, the network node 406 may send a request to the network node 404 for the L1 measurement metric(s) of the UE 402. Alternatively, or additionally, the network node 406 may send a request to the network node 404 that indicates to configure the UE 402 to generate training data, indicates to forward the training data, or both. In some cases, the network node 406 may autonomously generate beam prediction information using the beam management inference module and may autonomously send the beam prediction information to the network node 404 (e.g., without the network node 404 requesting the beam prediction information).

As indicated above, FIG. 4 is provided as an example. Other examples may differ from what is described with regard to FIG. 4.

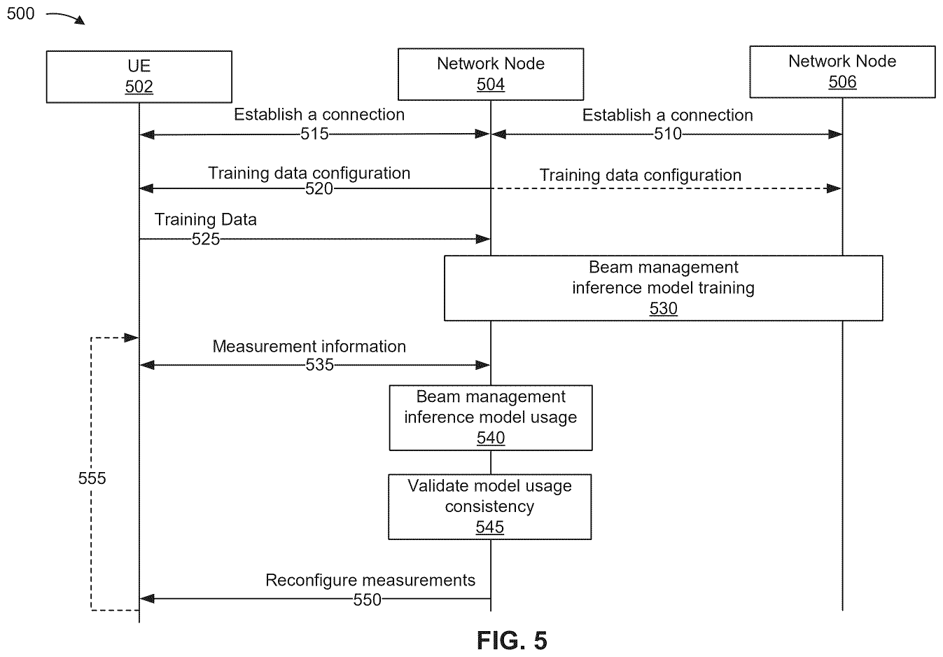

FIG. 5 is a diagram illustrating an example 500 of a wireless communication process between a UE 502 (e.g., a UE 120), a network node 504 (e.g., a first network node 110), and a network node 506 (a second network node 110). In some aspects, the network node 504 is a first node of a disaggregated network (e.g., a DU) and the network node 506 is a second node of a disaggregated network (e.g., a CU). The wireless communication process described with regard to the example 500 may be used to coordinate a beam management inference model being trained and applied at a same network node (e.g., a DU).

As shown by reference number 510, a network node 504 may establish a first connection with a network node 506. To illustrate, the network node 504 may be a DU of a disaggregated network and the network node 506 may be a CU of the disaggregated network. The network node 504 and the network node 506 may establish the first connection in a similar manner as described with regard to reference number 410 of FIG. 4.

As shown by reference number 515, the network node 504 may establish a second connection with a UE 502. To illustrate, the network node 504 and the UE 502 may establish the second connection in a similar manner as described with regard to reference number 415 of FIG. 4.

As shown by reference number 520, the network node 504 may transmit, and the UE 502 may receive, an indication of a training data configuration. Examples of information that may be included in the training data configuration are described above with regard to FIG. 4, such as a measurement metric type, a measurement metric threshold, a periodic measurement logging configuration, an event-triggered logging configuration, an event trigger threshold, a beam-based event, a specific beam identifier, and on-demand reporting of logged measurements.

As at least part of the training data configuration, the network node 504 may transmit a measurement logging configuration. For instance, the network node 504 may configure the UE 502 to log L1 measurement metrics periodically or based on specific events, such as radio condition-based events or beam-based events. Example radio condition-based events include configuring the UE 502 to log measurements based at least in part on a signal strength of a serving cell dropping below a predefined threshold or an SINR falling below a certain value. Example beam-based events include configuring the UE 502 to log measurements based at least in part on a specific beam becoming a top-ranked beam (e.g., in a set of beams) based on signal quality or based at least in part on a number of measurements for a beam being less than a configured value.

In some aspects, the network node 504 may communicate a training data configuration to the network node 506 (shown with a dotted line), and may include any combination of one or more measurement event triggers, one or more measurement configurations, or both. As one non-limiting example, the training data configuration communicated to the network node 506 may include any combination of an L1 event trigger, an L3 event trigger, or a periodicity for logging L1 measurement metrics to the network node 506. Optionally, the network node 504 may send a list of UE(s) to configure using an associated L1 measurement configuration. The network node 506 may configure the UE 502 in RRC signaling, and may configure the UE 502 to perform event-based L1 measurement logging, periodic L1 measurement logging, or both.

While the example 500 illustrates the network node 504 configuring a single UE (e.g., the UE 502) to perform training data collection, other examples may include the network node 504 configuring multiple UEs to perform training data collection. Alternatively, or additionally, the network node 504 may select the UE(s) to perform training data collection based at least in part on selection criteria, such as any combination of a UE location, a UE mobility pattern, and or a signal quality. The selection criteria may be based at least in part on one or more criteria of the beam management inference model, such as a diversity of beam angles, a frequency of beam switches, or historical performance metrics of the beams.

As shown by reference number 525, the UE 502 may transmit, and the network node 504 may receive, training data. In a similar manner as described with regard to the UE 402 in FIG. 4, the UE 502 may collect and log, as the training data, measurement information as specified by the training data configuration. Examples include L1-RSRP measurements, beam identifiers, signal quality indicators (e.g., SINR or CQI), and other relevant metrics such as L3 serving cell measurements and beam-based events.

Alternatively, or additionally, the network node 506 may send, and the network node 504 may receive (e.g., as training data), one or more L1 measurement metrics received by the network node 506 and from the UE 502 via RRC messaging. The network node 504 may, in some cases, use the L1 measurement metric(s) to train a beam management inference model. As another option, the network node 504 may receive, as training data, one or more L1 measurement metrics directly from the UE via PUCCH or PUSCH.

For clarity, FIG. 5 illustrates the UE 502 transmitting training data prior to the network node 504 performing beam management inference model training, but other examples may include the UE 502 transmitting the training data at other times than described with regard to the example 500. For example, the UE 502 may transmit the training data on-demand, periodically, or based on specific event triggers in a similar manner as described with regard to FIG. 4.

To illustrate, the network node 504 may monitor an L1 measurement threshold and, based at least in part on detecting that an L1 event trigger associated with the L1 measurement threshold has been reached, the network node 504 may configure the UE 502 to report L1 measurement metrics (e.g., as training data). In some cases, the network node 504 may dynamically adjust measurement metric generation, measurement metric reporting, or both, based at least in part on real-time network conditions. The network node 504 may use the reported L1 measurement metrics to train the beam management inference model in a similar manner as described with regard to FIG. 3.

As another example, the network node 504 may send a request to the network node 506 that indicates to forward one or more L3 measurement metric(s) to the network node 504. The network node 504 may use the L3 measurement metrics to monitor for, and detect, an occurrence of a measurement reporting event trigger, such as an L3 event trigger that is based at least in part on the L3 measurement metrics satisfying a reporting threshold. Based at least in part on detecting an occurrence of the measurement reporting trigger event, the network node 504 may configure the UE 502 to report training data (e.g., L1 measurement metric(s)) via PUCCH or PUSCH.

As shown by reference number 530, the network node 504 may perform beam management inference model training. In some cases, the network node 504 may communicate with the network node 506 as at least part of the beam management inference model training. For example, the network node 504 may request and obtain historical data, past measurement results associated with the measurement configuration, or a combination of the two, from the network node 506. The network node 504 may use the historical data or the past measurement results to train a beam management inference model, such as in a similar manner as described with regard to FIG. 3. Alternatively, or additionally, the network node 504 may use the training data collected from the UE 502.

As shown by reference number 535, the UE 502 may transmit, and the network node 504 may receive, link management measurement reporting information (e.g., a measurement metric, a beam identifier, or both). Alternatively, or additionally, the network node 504 may transmit, and the UE 502 may receive, link management measurement configuration information (e.g., specific measurement types to be logged, logging intervals, or event-triggered logging conditions). In a similar manner as described with regard to the UE 402 and network node 404 in FIG. 4, the network node 504 may use the link management measurement reporting to maintain the second connection with the UE 502.

As shown by reference number 540, the network node 504 may use the beam management inference model for link management. For example, in a similar manner as described with regard to the network node 404 in FIG. 4, the network node 504 may use one or more link management measurement reports from the UE 502 as input to the beam management inference model to generate beam predictions and adjust beam parameters.

In some cases, the network node 504 may request L3 measurement metric(s) from the network node 506 to determine whether to apply or use the beam management inference module to generate a beam prediction. Based at least in part on receiving the request, the network node 506 may forward one or more L3 measurement metrics to the network node 504 using the F1 interface. The network node 504 may determine whether to use the beam management inference model using the L1 measurement metric(s), the L3 measurement metric(s), or both. For example, the network node 504 may determine to use the beam management inference model based at least in part on an L1 measurement metric indicating that a signal strength (e.g., RSRP) of a current beam is below a predefined threshold. As another example, the network node 504 may use the L3 measurement metric(s) to compute or determine an activation state for the beam management inference model (e.g., to determine when to use or activate the beam management inference model). Based at least in part on computing a disabled activation state, the network node 504 may not to use the beam management inference model, and based at least in part on computing an enabled activation state, the network node 504 may use the beam management inference model to generate a beam prediction. An example of computing the activation state may include analyzing the L3 measurement metrics to determine if an overall signal quality of a serving cell (e.g., using an SINR measurement metric) is stable and satisfies a threshold.

In another example, the network node 504 may request an indication from the network node 506 to manage the application of the beam management inference model, such as an activation state that indicates whether to use the beam management inference model (e.g., an enabled activation state to activate or start using the beam management inference model) or not to use the beam management inference model (e.g., a disabled activation state to disable or stop using the beam management inference model). As an example, the network node 504 may send an indication of an L3 event threshold and, based at least in part on detecting an occurrence of an L3 event trigger using the L3 event threshold, the network node 506 may transmit an activation state to the network node 504. That is, the network node 506 may determine whether to use the beam management inference model based at least in part on L3 measurement metrics at the network node 506, and may communicate a simple indication instead of an entirety of LE measurement metrics, thereby reducing an amount of data exchanged between the network nodes.

As shown by reference number 545, the network node 504 may validate the beam management inference model usage. For example, the network node 504 may evaluate a predicted beam configuration against real-time measurement data to identify when the predicted beam configurations do not align with the actual performance metrics, such as by monitoring for an RSRP metric, for an SINR metric, for a beam failure report (e.g., from the UE 502), or for a beam switch indication (e.g., from the UE 502). As one example, an unexpected drop in the RSRP metric may indicate that the predicted beam configuration generated by the beam management inference model is not an optimal beam configuration, and a significant change (e.g., a change that satisfies a change threshold) in the SINR metric may indicate increased interference or suboptimal beamforming by the predicted beam configuration.

As shown by reference number 550, the network node 504 may transmit, and the UE 502 may receive, an indication of a measurement reconfiguration. For example, the network node 504 may adjust one or more measurement parameters, one or more logging configurations, or any combination thereof. To illustrate, the network node 504 may adjust a logging interval to increase the frequency of measurement reporting and obtain more granular data for analysis. Alternatively, or additionally, the network node 504 may adjust event-triggered logging conditions to achieve more accurate detection of specific network events, such as beam failures or significant changes in signal quality. Adjusting measurement parameters or logging parameters may ensure that the data collected is both relevant and useful for optimizing the beam management inference model.

As shown by reference number 550, the UE 502 and the network node 504 may iteratively exchange link management measurement reporting information, use the beam management inference model for link management, validate model usage consistency, and reconfigure measurements. For instance, the UE 502 may iteratively transmit link management measurement reports to the network node 504, the network node 504 may iteratively use these reports as input to the beam management inference model to generate beam predictions and adjust beam parameters, the network node 504 may iteratively validate the consistency between the predicted beam configurations and the actual performance metrics, and the network node 504 may reconfigure one or more measurements at the UE 502.

Using a same network node (e.g., a DU) to train and use a beam management inference model may enable the network node to leverage real-time data and immediate feedback to continuously refine and optimize a beam management inference model. Alternatively, or additionally, the use of a same network node may mitigate discrepancies between the training environment and the operational environment, resulting in consistency between the training and the application of a beam management inference model. Maintaining the consistency may result in improved accuracy of beam predictions, enhanced signal quality, reduced interference, and optimized resource allocation. Maintaining the consistency may also ensure that the network can provide a more reliable and efficient communication experience for users, ultimately leading to better overall network performance and user satisfaction.

As indicated above, FIG. 5 is provided as an example. Other examples may differ from what is described with regard to FIG. 5.

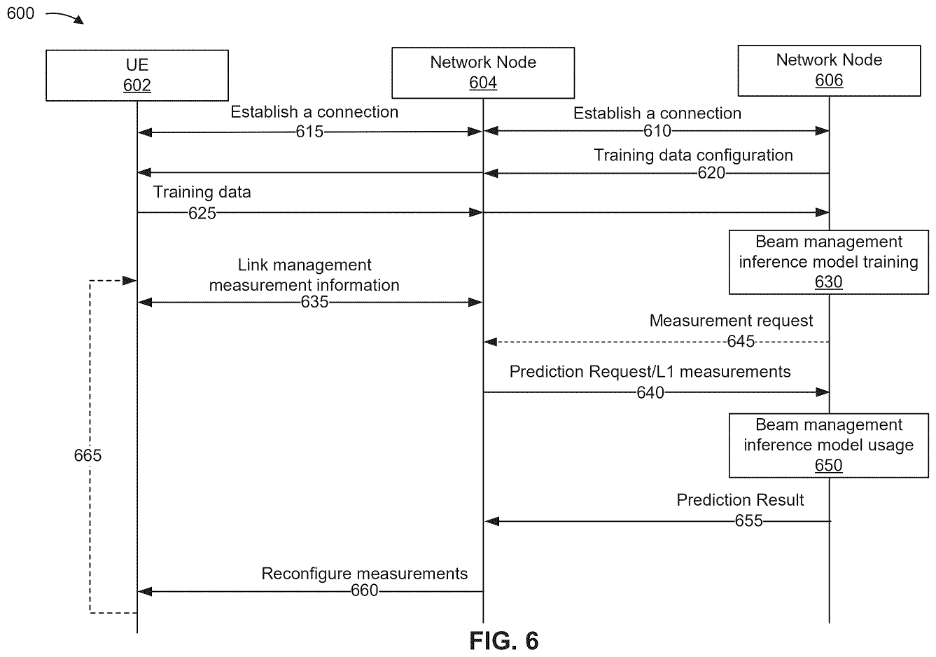

FIG. 6 is a diagram illustrating an example 600 of a wireless communication process between a UE 602 (e.g., the UE 120), a network node 604 (e.g., a first network node 110), and a network node 606 (a second network node 110). In some aspects, the network node 604 is a first node of a disaggregated network (e.g., a DU) and the network node 606 is a second node of a disaggregated network (e.g., a CU). The wireless communication process described with regard to the example 600 may be used to coordinate a beam management inference model being trained and applied at a same network node (e.g., a CU).

As shown by reference number 610, a network node 604 may establish a first connection with a network node 606. To illustrate, the network node 604 may be a DU of a disaggregated network and the network node 606 may be a CU of the disaggregated network, and may establish the first connection in a similar manner as described with regard to FIG. 4 and FIG. 5.

As shown by reference number 615, the network node 604 may establish a second connection with a UE 602. To illustrate, the network node 604 and the UE 602 may establish the first connection in a similar manner as described with regard to FIG. 4 and FIG. 5.

As shown by reference number 620, the network node 606 may transmit, and the network node 604 may receive, an indication of a training data configuration. For example, the network node 606 may transmit the training data configuration in a similar manner as described with regard to FIG. 4 and FIG. 5. The training data configuration may include any combination of information as described with regard to FIG. 4 and FIG. 5, such as one or more measurement types (e.g., L1 measurement metrics like RSRP), beam identifiers, measurement logging intervals, event-triggered logging configurations (e.g., based on L3 serving cell measurement thresholds or beam-based events), or on-demand reporting of logged measurements.

In some aspects, the network node 606 may select one or more UEs to perform training data collection. For example, the network node 606 may select the UE(s) for training data collection based at least in part on selection criteria, such as any combination of a UE location, a UE mobility pattern, and or a signal quality. Alternatively, or additionally, the selection criteria may be based at least in part on one or more criteria of the beam management inference model, such as a diversity of beam angles, a frequency of beam switches, or historical performance metrics of the beams. The network node 606 may indicate the selection of UE(s) to the network node 604.

As shown by FIG. 6, based at least in part on receiving the training data configuration, the network node 604 may transmit, and the UE 602 may receive, at least a portion of the training data configuration. For example, the network node 604 may forward the training data configuration in a similar manner as described with regard to FIG. 4.

As shown by reference number 625, the UE 602 may transmit, and the network node 604 may receive, training data. Alternatively, or additionally, the network node 604 may transmit, and the network node 606 may receive, the training data. As one example, the UE 602 may transmit, and the network node 604 may receive the training data in RRC signaling, and the network node 604 may forward the training data to the network node 606 using an F1 interface. In some cases, the network node 604 may receive one or more L1 measurement metrics directly from the UE 602 via PUCCH.

For clarity, FIG. 6 illustrates the UE 602 transmitting training data prior to the network node performing beam management inference model training, but other examples may include the UE 602 transmitting the training data at other times than described with regard to the example 600, such as by transmitting the training data on-demand, periodically, or based on specific event triggers as described with regard to FIG. 4 and FIG. 5

As shown by reference number 630, the network node 606 may perform beam management inference model training. To illustrate, in a similar manner as described with regard to FIG. 4, the network node 606 may use historical data, past measurement results associated with the measurement configuration, or training data obtained from the UE 602 to train the beam management inference model in a similar manner as described with regard to FIG. 3.

As shown by reference number 635, the UE 602 may transmit, and the network node 604 may receive, link management measurement reporting information (e.g., a measurement metric, a beam identifier, or both). Alternatively, or additionally, the network node 604 may transmit, and the UE 602 may receive, link management measurement configuration information (e.g., specific measurement types to be logged, logging intervals, or event-triggered logging conditions). In some aspects, the link management measurement configuration information and the link management measurement reporting information may be separate from training data and may be part of standard link management operations. That is, the link management measurement configuration and link management measurement reporting may be used for maintaining and optimizing the link quality between the UE 602 and the network node 604.

As shown by reference number 640, the network node 604 may transmit, and the network node 606 may receive, a request for a beam prediction (e.g., a prediction request), one or more measurement metrics (e.g., L1 measurement metric(s)), or both. For instance, the network node 604 may transmit a prediction request, the measurement metric(s), or both, based at least in part on detecting an event trigger. As one example, the network node 604 may transmit a prediction request, the measurement metric(s), or both, based at least in part on detecting an event trigger. To illustrate, the network node 604 may monitor for a specific L1 measurement event trigger that serves as a trigger for requesting a beam prediction from the network node 606. An example L1 measurement event trigger may include a signal strength (e.g., L1-RSRP) of a current beam dropping below a predefined threshold. Accordingly, the network node 604 may autonomously transmit the measurement metrics, the prediction request, or both, to the network node 606 without waiting for an explicit request from the network node 606. In some cases, the network node 604 may include historical measurement data or context information in the prediction request to provide the network node 606 with a comprehensive view of the network conditions.

Alternatively, the network node 604 may receive a measurement request from the network node 606 as shown by reference number 645, and may transmit the requested L1 measurement metric(s), the prediction request, or both based at least in part on receiving the measurement request. To illustrate, the network node 606 may transmit the measurement request based at least in part on detecting an occurrence of a measurement request event trigger, such as by detecting, as the measurement request event trigger, an L3 event trigger using one or more L3 measurement metrics at the network node 606, such as an L3 event trigger that is based at least in part on L3 measurement metric(s) satisfying a threshold.

As shown by reference number 650, the network node 606 may use the beam management inference model determine an activation state (e.g., enabled or disabled) for using the beam management inference model. As an example, the network node 606 may determine the activation state of the beam management inference model (e.g., may determine whether to use the beam management inference model) by analyzing the L3 measurement metric(s) to derive a signal quality and current network conditions. The network node 606 may determine an enabled activation state for the beam management inference model based at least in part on the L3 measurement metric(s) indicating that a signal quality has degraded. Alternatively, the network node 606 may determine a disabled activation state for the beam management inference model based at least in part on the L3 measurement metrics indicating a stable, high signal quality.

Alternatively, or additionally, the network node 606 may determine the activation state (e.g., whether to use the beam management inference model) based on the L1 measurement metrics received from the network node 604. For instance, the network node 606 may use one or more L1 measurement metrics, such as RSRP or SINR, to evaluate a current network condition and whether to use the beam management inference model to generate a beam prediction information. In a similar manner as described above, the beam prediction information may include information such as the top K beams within a set of beams with the highest predicted RSRP or SINR, or other relevant metrics.

Based at least in part on determining to use the beam management inference model, the network node 606 may generate beam prediction information using the beam management inference model, such as beam prediction information that indicates the top K beams within a set of beams with the highest RSRP, SINR, or other relevant metrics. As shown by reference number 655, the network node 606 may transmit, and the network node 604 may receive, a prediction result, such as beam prediction information.

As shown by reference number 660, the network node 604 may transmit, and the UE 602 may receive, an indication of a measurement reconfiguration. For example, the network node 604 may adjust one or more measurement parameters, one or more logging configurations, or any combination thereof, based at least in part on the beam prediction information. To illustrate, the network node 604 may adjust a logging interval to increase the frequency of measurement reporting and obtain more granular data for analysis. Alternatively, or additionally, the network node 604 may adjust event-triggered logging conditions to achieve more accurate detection of specific network events, such as beam failures or significant changes in signal quality. Adjusting measurement parameters or logging parameters may ensure that the data collected is both relevant and useful for optimizing the beam management inference model.

As shown by reference number 665, the UE 602, the network node 604, and the network node 606 may iteratively exchange link management measurement reporting information, transmit prediction requests and measurement metrics, use the beam management inference model to generate beam predictions, transmit prediction results, and reconfigure measurements at the UE 602. The use of an iterative process ensures that the beam management inference model is continuously updated and optimized based on real-time data and feedback.

Training and using a beam management inference model at a single network entity, such as a CU, ensures a consistency between a model training environment and a deployment operational environment, resulting in more accurate and reliable beam predictions. Alternatively, or additionally, training and using a beam management inference model at a single network entity may simplify coordination and reduce latency in decision-making.

As indicated above, FIG. 6 is provided as an example. Other examples may differ from what is described with regard to FIG. 6.

FIG. 7 is a diagram illustrating an example process 700 performed, for example, at a network node or an apparatus of a network node. Example process 700 is an example where the apparatus or the network node (e.g., network node 110) performs operations associated with beam management inference model coordination in a disaggregated network.

As shown in FIG. 7, in some aspects, process 700 may include transmitting an indication of a training data configuration for collecting training data that is associated with generation of a beam management inference model (block 710). For example, the network node (e.g., using transmission component 1104 or communication manager 1106, depicted in FIG. 11) may transmit an indication of a training data configuration for collecting training data that is associated with generation of a beam management inference model, as described above.

As further shown in FIG. 7, in some aspects, process 700 may include receiving the training data that is based at least in part on the training data configuration (block 720). For example, the network node (e.g., using reception component 1102 or communication manager 1106, depicted in FIG. 11) may receive the training data that is based at least in part on the training data configuration, as described above.

As further shown in FIG. 7, in some aspects, process 700 may include generating the beam management inference model using the training data (block 730). For example, the network node (e.g., using communication manager 1106, depicted in FIG. 11) may generate the beam management inference model using the training data, as described above.

As further shown in FIG. 7, in some aspects, process 700 may include transmitting, as at least part of a deployment of the beam management inference model, the indication of the training data configuration (block 740). For example, the network node (e.g., using transmission component 1104 or communication manager 1106, depicted in FIG. 11) may transmit, as at least part of a deployment of the beam management inference model, the indication of the training data configuration, as described above.

Process 700 may include additional aspects, such as any single aspect or any combination of aspects described below or in connection with one or more other processes described elsewhere herein.

In a first aspect, the training data configuration indicates at least one of a measurement metric type, a measurement metric threshold, a periodic measurement logging configuration, an event-triggered logging configuration, an event trigger threshold, a beam-based event, one or more specific beam identifiers, or on-demand reporting of logged measurements.

In a second aspect, the network node is a CU and the deployment of the beam management inference model is directed to a DU.

In a third aspect, process 700 includes selecting one or more UEs to use for collecting the training data.

In a fourth aspect, process 700 includes receiving a proposed measurement configuration from the DU, and generating the training data configuration based at least in part on the proposed measurement configuration, and transmitting the indication of the training data configuration includes transmitting an instruction that directs the DU to transmit the indication of the training data configuration in radio resource control signaling that is directed to a UE.

In a fifth aspect, the proposed measurement configuration includes at least one of: a set of proposed beams; an L3 measurement metric threshold, an L1 measurement metric threshold, a periodicity, or a beam-based event.

In a sixth aspect, process 700 includes configuring the DU to request the training data from a UE that is configured based at least in part on the training data configuration.

In a seventh aspect, receiving the training data includes receiving the training data from the UE via the DU.

In an eighth aspect, receiving the training data includes receiving the training data from the UE via radio resource control messaging that is directed to the CU.

In a nineth aspect, receiving the training data includes receiving the training data from the UE via the DU in physical uplink control channel messaging.

In a tenth aspect, the network node is a control unit, and process 700 includes monitoring for a measurement request event trigger, detecting an occurrence of the measurement report event trigger, and requesting that the DU configure training data and forward, as at least part of the training data, one or more measurement results based at least in part on detecting the occurrence of the measurement request event trigger.

In an eleventh aspect, the network node is a control unit, and process 700 includes configuring a DU with one or more L1 measurement request event triggers, and forwarding one or more layer 3 measurement results to the DU that are associated with the one or more L1 measurement request event triggers.

In an twelfth aspect, process 700 includes receiving, as the training data, one or more L1 measurement metrics that are based at least in part on the one or more L1 measurement request event triggers.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with beam management inference model coordination in a disaggregated network.

As shown in FIG. 8, in some aspects, process 800 may include receiving a beam management inference model and an indication of a training data configuration that is associated with the beam management inference model (block 810). For example, the network node (e.g., using reception component 1102 or communication manager 1106, depicted in FIG. 11) may receive a beam management inference model and an indication of a training data configuration that is associated with the beam management inference model, as described above.

As further shown in FIG. 8, in some aspects, process 800 may include deriving an activation state for using the beam management inference model based at least in part on at least one of: a current operating condition, or one or more criteria indicated by the training data configuration (block 820). For example, the network node (e.g., using communication manager 1106, depicted in FIG. 11) may derive an activation state for using the beam management inference model based at least in part on at least one of: a current operating condition, or one or more criteria indicated by the training data configuration, as described above.

As further shown in FIG. 8, in some aspects, process 800 may include applying the beam management inference model for beam management selectively and based at least in part on the activation state (block 830). For example, the network node (e.g., using communication manager 1106, depicted in FIG. 11) may apply the beam management inference model for beam management selectively and based at least in part on the activation state, as described above.

Process 800 may include additional aspects, such as any single aspect or any combination of aspects described below or in connection with one or more other processes described elsewhere herein.

In a first aspect, the one or more criteria indicated by the training data configuration include at least one of a layer 1 measurement threshold, a layer 3 measurement threshold, an event trigger threshold, a beam-based event, or one or more specific beam IDs.

In a second aspect, process 800 includes transmitting a request for one or more L3 measurement metrics, and receiving the one or more L3 measurement metrics, and determining that the current operating condition satisfies the one or more criteria includes comparing the one or more L3 measurement metrics to an L3 measurement threshold.

In a third aspect, the indication is a first indication, and process 800 includes receiving a second indication of the activation state, the second indication of the activation state being based at least in part on one or more layer 3 measurements.

In a fourth aspect, the indication is a first indication, and process 800 includes receiving one or more respective beam performance reports from one or more UEs, computing performance information of the beam management inference model based at least in part on the one or more respective beam performance reports, and transmitting a second indication of the performance information.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with beam management inference model coordination in a disaggregated network.

As shown in FIG. 9, in some aspects, process 900 may include selecting one or more UEs for collecting training data that is associated with generation of a beam management inference model (block 910). For example, the network node (e.g., using communication manager 1106, depicted in FIG. 11) may select one or more UEs for collecting training data that is associated with generation of a beam management inference model, as described above.

As further shown in FIG. 9, in some aspects, process 900 may include transmitting an indication of a training data configuration to configure the one or more UEs for collecting the training data (block 920). For example, the network node (e.g., using transmission component 1104 or communication manager 1106, depicted in FIG. 11) may transmit an indication of a training data configuration to configure the one or more UEs for collecting the training data, as described above.

As further shown in FIG. 9, in some aspects, process 900 may include receiving the training data, the training data being based at least in part on the training data configuration (block 930). For example, the network node (e.g., using reception component 1102 or communication manager 1106, depicted in FIG. 11) may receive the training data, the training data being based at least in part on the training data configuration, as described above.

As further shown in FIG. 9, in some aspects, process 900 may include generating the beam management inference model using the training data (block 940). For example, the network node (e.g., using communication manager 1106, depicted in FIG. 11) may generate the beam management inference model using the training data, as described above.

Process 900 may include additional aspects, such as any single aspect or any combination of aspects described below or in connection with one or more other processes described elsewhere herein.

In a first aspect, process 900 includes requesting one or more L3 measurement metrics from a CU to compute an activation state for the beam management inference model, receiving the one or more L3 measurement metrics, and computing the activation state using the one or more L3 measurement metrics.

In a second aspect, the indication is a first indication, and process 900 includes communicating an L3 event threshold to a control unit that is associated with using the beam management inference model, receiving a second indication of an activation state for the beam management inference model, the activation state being based at least in part on the L3 event threshold, and using the beam management inference model selectively based at least in part on the activation state.

In a third aspect, process 900 includes sending a training data configuration to a CU, the training data configuration indicating at least one of: one or more measurement event triggers or one or more measurement configurations.

In a fourth aspect, process 900 includes receiving the training data from the CU, the training data being based at least in part on the training data configuration.

In a fifth aspect, process 900 includes receiving the training data from the one or more UEs.

In a sixth aspect, the indication is a first indication, and process 900 includes sending a second indication of the one or more UEs to the CU.

In a seventh aspect, process 900 includes monitoring a measurement reporting event trigger, detecting an occurrence of the measurement reporting event trigger, and transmitting a request for the training data based at least in part on detecting the occurrence.

In an eighth aspect, the measurement request event trigger includes an L3 measurement reporting event trigger, the request is a first request, and process 900 includes communicating a second request for one or more L3 measurement metrics from a control unit, and receiving the one or more L3 measurement metrics.

In a ninth aspect, the network node is a first network node, the indication is a first indication, and process 900 includes transmitting a second indication of an L1 measurement configuration to a second network node, and transmitting, to the second network node, an L3 event threshold that indicates a event trigger for using the L1 measurement configuration.

In a tenth aspect, receiving the training data includes receiving one or more L1 measurement metrics from the second network node based at least in part on the L3 event threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with beam management inference model coordination in a disaggregated network.

As shown in FIG. 10, in some aspects, process 1000 may include selecting one or more UEs for collecting training data that is associated with generation of a beam management inference model (block 1010). For example, the network node (e.g., using communication manager 1106, depicted in FIG. 11) may select one or more UEs for collecting training data that is associated with generation of a beam management inference model, as described above.

As further shown in FIG. 10, in some aspects, process 1000 may include transmitting an indication of a training data configuration to configure the one or more UEs for collecting the training data (block 1020). For example, the network node (e.g., using transmission component 1104 or communication manager 1106, depicted in FIG. 11) may transmit an indication of a training data configuration to configure the one or more UEs for collecting the training data, as described above.

As further shown in FIG. 10, in some aspects, process 1000 may include receiving the training data, the training data being based at least in part on the training data configuration (block 1030). For example, the network node (e.g., using reception component 1102 or communication manager 1106, depicted in FIG. 11) may receive the training data, the training data being based at least in part on the training data configuration, as described above.

As further shown in FIG. 10, in some aspects, process 1000 may include generating the beam management inference model using the training data (block 1040). For example, the network node (e.g., using communication manager 1106, depicted in FIG. 11) may generate the beam management inference model using the training data, as described above.

As further shown in FIG. 10, in some aspects, process 1000 may include applying the beam management inference model for beam management selectively using an activation state (e.g., an activation state that indicates whether to use the beam management inference model), the activation state being based at least in part on at least one of: a current operating condition, or one or more criteria indicated by the training data configuration (block 1050). For example, the network node (e.g., using communication manager 1106, depicted in FIG. 11) may apply the beam management inference model for beam management selectively using an activation state, the activation state being based at least in part on at least one of: a current operating condition, or one or more criteria indicated by the training data configuration, as described above.

Process 1000 may include additional aspects, such as any single aspect or any combination of aspects described below or in connection with one or more other processes described elsewhere herein.

In a first aspect, the one or more criteria include an L1 measurement event, and process 1000 includes receiving one or more L1 measurement metrics, and determining the activation state based at least in part on the one or more L1measurement metrics and the L1 measurement event.

In a second aspect, the one or more criteria include an L3 measurement event, and process 1000 includes computing one or more L3 measurement metrics, receiving one or more L1 measurement metrics, receiving a request for beam prediction, and determining, based on the one or more L1 measurement metrics and the one or more L3 measurement metrics, the activation state.

In a third aspect, the activation state is an enabled activation state, the indication is a first indication, and process 1000 includes generating the beam prediction using the beam management inference model, and transmitting a second indication of the beam prediction.

In a fourth aspect, process 1000 includes transmitting a request for the one or more L1 measurement metrics, and receiving the one or more L1 measurement metrics is based at least in part on the request.

In a fifth aspect, process 1000 includes detecting an occurrence of an L3 event trigger using one or more L3 measurement metric, and transmitting the request is based at least in part on detecting the occurrence.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a network node, or a network node may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 3-6. Additionally, or alternatively, the apparatus 1100 may be configured to perform one or more processes described herein, such as process 600 of FIG. 6, process 700 of FIG. 7, process 800 of FIG. 8, or a combination thereof. In some aspects, the apparatus 1100 or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 or the transmission component 1104 may include or may be included in a network interface. The network interface may be configured to obtain or output signals for the apparatus 1100 via one or more communications links, such as a backhaul link, a midhaul link, or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The transmission component 1104 may transmit an indication of a training data configuration for collecting training data that is associated with generation of a beam management inference model. The reception component 1102 may receive the training data that is based at least in part on the training data configuration. The communication manager 1106 may generate the beam management inference model using the training data. The transmission component 1104 may transmit, as at least part of a deployment of the beam management inference model, the indication of the training data configuration.

The communication manager 1106 may select one or more UEs to use for collecting the training data. In some cases, the reception component 1102 may receive a proposed measurement configuration from the DU. Alternatively, or additionally, the communication manager 1106 may generate the training data configuration based at least in part on the proposed measurement configuration. The communication manager 1106 may configure the DU to request the training data from a UE that is configured based at least in part on the training data configuration. In some cases, the reception component 1102 may receive, as the training data, one or more L1 measurements that are based at least in part on the one or more L1 measurement request event trigger.

The reception component 1102 may receive a beam management inference model and an indication of a training data configuration that is associated with the beam management inference model. The communication manager 1106 may derive an activation state for using the beam management inference model based at least in part on at least one of a current operating condition, or one or more criteria indicated by the training data configuration. The communication manager 1106 may apply the beam management inference model for beam management selectively and based at least in part on the activation state.

The transmission component 1104 may transmit a request for one or more L3 measurements. In some cases, the reception component 1102 may receive the one or more L3 measurements.

The communication manager 1106 may select one or more UEs for collecting training data that is associated with generation of a beam management inference model. The transmission component 1104 may transmit an indication of a training data configuration to configure the one or more UEs for collecting the training data. The reception component 1102 may receive the training data, the training data being based at least in part on the training data configuration. The communication manager 1106 may generate the beam management inference model using the training data.

The communication manager 1106 may request one or more L3 measurement metrics from a control unit to compute an activation state for using the beam management inference model. In some cases, the reception component 1102 may receive the one or more L3 measurements. Alternatively, or additionally, the communication manager 1106 may compute the activation state for using the one or more L3 measurements.

The communication manager 1106 may send a training data configuration to a CU, the training data configuration indicating at least one of one or more measurement event triggers, or one or more measurement configurations. In some cases, the reception component 1102 may receive the training data from the CU, the training data being based at least in part on the training data configuration. Alternatively, or additionally, the reception component 1102 may receive the training data from the one or more UEs.

The communication manager 1106 may monitor a measurement reporting event trigger. In some cases, the communication manager 1106 may detect an occurrence of the measurement reporting event trigger. Alternatively, or additionally, the transmission component 1104 may transmit a request for the training data based at least in part on detecting the occurrence.

The communication manager 1106 may select one or UEs for collecting training data that is associated with generation of a beam management inference model. The transmission component 1104 may transmit an indication of a training data configuration to configure the one or more UEs for collecting the training data. The reception component 1102 may receive the training data, the training data being based at least in part on the training data configuration. The communication manager 1106 may generate the beam management inference model using the training data. The communication manager 1106 may apply the beam management inference model for beam management selectively using an activation state, the activation state being based at least in part on at least one of a current operating condition, or one or more criteria indicated by the training data configuration.

The transmission component 1104 may transmit a request for the one or more L1 measurement metrics wherein receiving the one or more L1 measurement metrics is based at least in part on the request. In some cases, the communication manager 1106 may detect an occurrence of a L3 event trigger using one or more L3 measurement metric wherein transmitting the request is based at least in part on detecting the occurrence.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication by a network node, the method comprising: transmitting an indication of a training data configuration for collecting training data that is associated with generation of a beam management inference model; receiving the training data that is based at least in part on the training data configuration; generating the beam management inference model using the training data; and transmitting, as at least part of a deployment of the beam management inference model, the indication of the training data configuration.
Aspect 2: The method of Aspect 1, wherein the training data configuration indicates at least one of: a measurement metric type, a measurement metric threshold, a periodic measurement logging configuration, an event-triggered logging configuration, an event trigger threshold, a beam-based event, one or more specific beam identifiers, or on-demand reporting of logged measurements.
Aspect 3: The method of any of Aspects 1-2, wherein the network node is a control unit (CU) and the deployment of the beam management inference model is directed to a distributed unit (DU).
Aspect 4: The method of Aspect 3, further comprising: selecting one or more user equipments to use for collecting the training data.
Aspect 5: The method of Aspect 3, further comprising: receiving a proposed measurement configuration from the DU; and generating the training data configuration based at least in part on the proposed measurement configuration, wherein transmitting the indication of the training data configuration comprises: transmitting an instruction that directs the DU to transmit the indication of the training data configuration in radio resource control signaling that is directed to a user equipment.
Aspect 6: The method of Aspect 5, wherein the proposed measurement configuration comprises at least one of: a set of proposed beams; a layer 3 measurement metric threshold, a layer 1 measurement metric threshold, a periodicity, or a beam-based event.
Aspect 7: The method of Aspect 3, further comprising: configuring the DU to request the training data from a user equipment (UE) that is configured based at least in part on the training data configuration.
Aspect 8: The method of Aspect 7, wherein receiving the training data comprises: receiving the training data from the UE via the DU.
Aspect 9: The method of Aspect 8, wherein receiving the training data comprises: receiving the training data from the UE via radio resource control messaging that is directed to the CU.
Aspect 10: The method of Aspect 8, wherein receiving the training data comprises: receiving the training data from the UE via the DU in physical uplink control channel messaging.
Aspect 11: The method of any of Aspects 1-10, wherein the network node is a control unit, and wherein the method further comprises: monitoring for a measurement report event trigger; detecting an occurrence of the measurement request event trigger; and requesting that a distributed unit (DU) configure training data and forward, as at least part of the training data, one or more measurement results based at least in part on detecting the occurrence of the measurement request event trigger.
Aspect 12: The method of any of Aspects 1-11, wherein the network node is a control unit, and wherein the method further comprises: configuring a distributed unit (DU) with one or more layer 1 (L1) measurement request event trigger; and forwarding one or more layer 3 measurement results to the DU that are associated with the one or more L1 measurement request event trigger.
Aspect 13: The method of Aspect 11, further comprising: receiving, as the training data, one or more L1 measurements that are based at least in part on the one or more L1 measurement request event trigger.
Aspect 14: A method of wireless communication by a network node, the method comprising: receiving a beam management inference model and an indication of a training data configuration that is associated with the beam management inference model; deriving an activation state for using the beam management inference model based at least in part on at least one of: a current operating condition, or one or more criteria indicated by the training data configuration; and applying the beam management inference model for beam management selectively and based at least in part on the activation state.
Aspect 15: The method of Aspect 14, wherein the one or more criteria indicated by the training data configuration comprise at least one of: a layer 1 measurement threshold, a layer 3 measurement threshold, an event trigger threshold, a beam-based event, or one or more specific beam IDs.
Aspect 16: The method of any of Aspects 14-15, further comprising: transmitting a request for one or more layer 3 (L3) measurements; and receiving the one or more L3 measurements, wherein determining that the current operating condition satisfies the one or more criteria comprises: comparing the one or more L3 measurements to an L3 measurement threshold.
Aspect 17: The method of any of Aspects 14-16, wherein the indication is a first indication, and wherein the method further comprises: receiving a second indication of the activation state, the second indication of the activation state being based at least in part on one or more layer 3 measurements.
Aspect 18: The method of any of Aspects 14-17, wherein the indication is a first indication, and wherein the method further comprises: receiving one or more respective beam performance reports from one or more user equipments; computing performance information of the beam management inference model based at least in part on the one or more respective beam performance reports; and transmitting a second indication of the performance information.
Aspect 19: A method of wireless communication by a network node, the method comprising: selecting one or more user equipments (UEs) for collecting training data that is associated with generation of a beam management inference model; transmitting an indication of a training data configuration to configure the one or more UEs for collecting the training data; receiving the training data, the training data being based at least in part on the training data configuration; and generating the beam management inference model using the training data.
Aspect 20: The method of Aspect 19, further comprising: requesting one or more layer 3 (L3) measurement metrics from a control unit to compute an activation state for using the beam management inference model; receiving the one or more L3 measurements; and computing the activation state for using the one or more L3 measurements.
Aspect 21: The method of any of Aspects 19-20, wherein the indication is a first indication, and wherein the method further comprises: communicating a layer 3 (L3) event threshold to a control unit that is associated with using the beam management inference model; receiving a second indication of an activation state for the beam management inference model, the activation state being based at least in part on the L3 event threshold; and using the beam management inference model selectively based at least in part on the activation state.
Aspect 22: The method of any of Aspects 19-21, further comprising: sending a training data configuration to a control unit (CU), the training data configuration indicating at least one of: one or more measurement event triggers, or one or more measurement configurations.
Aspect 23: The method of Aspect 22, further comprising: receiving the training data from the CU, the training data being based at least in part on the training data configuration.
Aspect 24: The method of Aspect 22, further comprising: receiving the training data from the one or more UEs.
Aspect 25: The method of Aspect 22, wherein the indication is a first indication, and wherein the method further comprises: sending a second indication of the one or more UEs to the CU.
Aspect 26: The method of any of Aspects 19-25, further comprising: monitoring a measurement reporting event trigger; detecting an occurrence of the measurement reporting event trigger; and transmitting a request for the training data based at least in part on detecting the occurrence.
Aspect 27: The method of Aspect 26, wherein the measurement reporting event trigger comprises a layer 3 (L3) measurement reporting event trigger, wherein the request is a first request, and wherein the method further comprises: communicating a second request for one or more L3 measurement metrics from a control unit; and receiving the one or more L3 measurement metrics.
Aspect 28: The method of any of Aspects 19-27, wherein the network node is a first network node, wherein the indication is a first indication, and wherein the method further comprises: transmitting a second indication of a layer 1 (L1) measurement configuration to a second network node; and transmitting, to the second network node, a layer 3 (L3) event threshold that indicates an event trigger for using the L1 measurement configuration.
Aspect 29: The method of Aspect 28, wherein receiving the training data comprises: receiving one or more L1 measurements from the second network node based at least in part on the L3 event threshold.
Aspect 30: A method of wireless communication by a network node, the method comprising: selecting one or more user equipments (UEs) for collecting training data that is associated with generation of a beam management inference model; transmitting an indication of a training data configuration to configure the one or more UEs for collecting the training data; receiving the training data, the training data being based at least in part on the training data configuration; generating the beam management inference model using the training data; and applying the beam management inference model for beam management selectively using an activation state, the activation state being based at least in part on at least one of: a current operating condition, or one or more criteria indicated by the training data configuration.
Aspect 31: The method of Aspect 30, wherein the one or more criteria comprise a layer 1 (L1) measurement event, and wherein the method further comprises: receiving one or more L1 measurement metrics; and determining the activation state based at least in part on the one or more L1 measurement metrics and the L1 measurement event.
Aspect 32: The method of Aspect 31, wherein the one or more criteria comprise a layer 3 (L3) measurement event, and wherein the method further comprises: computing one or more layer 3 (L3) measurement metrics; receiving one or more layer 1 (L1) measurement metrics; receiving a request for beam prediction; and determining the activation state, based on at least in part on at least one of: the one or more L1 measurement metrics, or the one or more L3 measurement metrics.
Aspect 33: The method of Aspect 32, wherein the activation state is an enabled activation state, wherein the indication is a first indication, and wherein the method further comprises: generating the beam prediction using the beam management inference model; and transmitting a second indication of the beam prediction.
Aspect 34: The method of Aspect 31, further comprising: transmitting a request for the one or more L1 measurement metrics, wherein receiving the one or more L1 measurement metrics is based at least in part on the request.
Aspect 35: The method of Aspect 34, further comprising: detecting an occurrence of a layer 3 (L3) event trigger using one or more L3 measurement metric, wherein transmitting the request is based at least in part on detecting the occurrence.
Aspect 36: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.
Aspect 37: An apparatus for wireless communication at a device, the apparatus comprising one or more memories and one or more processors coupled to the one or more memories, the one or more processors configured to cause the device to perform the method of one or more of Aspects 1-13.
Aspect 38: An apparatus for wireless communication, the apparatus comprising at least one means for performing the method of one or more of Aspects 1-13.
Aspect 39: A non-transitory computer-readable medium storing code for wireless communication, the code comprising instructions executable by one or more processors to perform the method of one or more of Aspects 1-13.
Aspect 40: A non-transitory computer-readable medium storing a set of instructions for wireless communication, the set of instructions comprising one or more instructions that, when executed by one or more processors of a device, cause the device to perform the method of one or more of Aspects 1-13.
Aspect 41: A device for wireless communication, the device comprising a processing system that includes one or more processors and one or more memories coupled with the one or more processors, the processing system configured to cause the device to perform the method of one or more of Aspects 1-13.
Aspect 42: An apparatus for wireless communication at a device, the apparatus comprising one or more memories and one or more processors coupled to the one or more memories, the one or more processors individually or collectively configured to cause the device to perform the method of one or more of Aspects 1-13.
Aspect 43: A device comprising a processing system that includes one or more processors and one or more code-storing memories coupled with the one or more processors, the processing system configured to cause the device to perform the method of one or more of Aspects 1-13.
Aspect 44: A device comprising a processing system that includes processor circuitry and code-storing memory circuitry, the processing system configured to cause the device to perform the method of one or more of Aspects 1-13.
Aspect 45: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 14-18.
Aspect 46: An apparatus for wireless communication at a device, the apparatus comprising one or more memories and one or more processors coupled to the one or more memories, the one or more processors configured to cause the device to perform the method of one or more of Aspects 14-18.
Aspect 47: An apparatus for wireless communication, the apparatus comprising at least one means for performing the method of one or more of Aspects 14-18.
Aspect 48: A non-transitory computer-readable medium storing code for wireless communication, the code comprising instructions executable by one or more processors to perform the method of one or more of Aspects 14-18.
Aspect 49: A non-transitory computer-readable medium storing a set of instructions for wireless communication, the set of instructions comprising one or more instructions that, when executed by one or more processors of a device, cause the device to perform the method of one or more of Aspects 14-18.
Aspect 50: A device for wireless communication, the device comprising a processing system that includes one or more processors and one or more memories coupled with the one or more processors, the processing system configured to cause the device to perform the method of one or more of Aspects 14-18.
Aspect 51: An apparatus for wireless communication at a device, the apparatus comprising one or more memories and one or more processors coupled to the one or more memories, the one or more processors individually or collectively configured to cause the device to perform the method of one or more of Aspects 14-18.
Aspect 52: A device comprising a processing system that includes one or more processors and one or more code-storing memories coupled with the one or more processors, the processing system configured to cause the device to perform the method of one or more of Aspects 14-18.
Aspect 53: A device comprising a processing system that includes processor circuitry and code-storing memory circuitry, the processing system configured to cause the device to perform the method of one or more of Aspects 14-18.
Aspect 54: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 19-29.
Aspect 55: An apparatus for wireless communication at a device, the apparatus comprising one or more memories and one or more processors coupled to the one or more memories, the one or more processors configured to cause the device to perform the method of one or more of Aspects 19-29.
Aspect 56: An apparatus for wireless communication, the apparatus comprising at least one means for performing the method of one or more of Aspects 19-29.
Aspect 57: A non-transitory computer-readable medium storing code for wireless communication, the code comprising instructions executable by one or more processors to perform the method of one or more of Aspects 19-29.
Aspect 58: A non-transitory computer-readable medium storing a set of instructions for wireless communication, the set of instructions comprising one or more instructions that, when executed by one or more processors of a device, cause the device to perform the method of one or more of Aspects 19-29.
Aspect 59: A device for wireless communication, the device comprising a processing system that includes one or more processors and one or more memories coupled with the one or more processors, the processing system configured to cause the device to perform the method of one or more of Aspects 19-29.
Aspect 60: An apparatus for wireless communication at a device, the apparatus comprising one or more memories and one or more processors coupled to the one or more memories, the one or more processors individually or collectively configured to cause the device to perform the method of one or more of Aspects 19-29.
Aspect 61: A device comprising a processing system that includes one or more processors and one or more code-storing memories coupled with the one or more processors, the processing system configured to cause the device to perform the method of one or more of Aspects 19-29.
Aspect 62: A device comprising a processing system that includes processor circuitry and code-storing memory circuitry, the processing system configured to cause the device to perform the method of one or more of Aspects 19-29.
Aspect 63: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 30-35.
Aspect 64: An apparatus for wireless communication at a device, the apparatus comprising one or more memories and one or more processors coupled to the one or more memories, the one or more processors configured to cause the device to perform the method of one or more of Aspects 30-35.
Aspect 65: An apparatus for wireless communication, the apparatus comprising at least one means for performing the method of one or more of Aspects 30-35.
Aspect 66: A non-transitory computer-readable medium storing code for wireless communication, the code comprising instructions executable by one or more processors to perform the method of one or more of Aspects 30-35.
Aspect 67: A non-transitory computer-readable medium storing a set of instructions for wireless communication, the set of instructions comprising one or more instructions that, when executed by one or more processors of a device, cause the device to perform the method of one or more of Aspects 30-35.
Aspect 68: A device for wireless communication, the device comprising a processing system that includes one or more processors and one or more memories coupled with the one or more processors, the processing system configured to cause the device to perform the method of one or more of Aspects 30-35.
Aspect 69: An apparatus for wireless communication at a device, the apparatus comprising one or more memories and one or more processors coupled to the one or more memories, the one or more processors individually or collectively configured to cause the device to perform the method of one or more of Aspects 30-35.
Aspect 70: A device comprising a processing system that includes one or more processors and one or more code-storing memories coupled with the one or more processors, the processing system configured to cause the device to perform the method of one or more of Aspects 30-35.
Aspect 71: A device comprising a processing system that includes processor circuitry and code-storing memory circuitry, the processing system configured to cause the device to perform the method of one or more of Aspects 30-35.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network node, comprising:
a processing system that includes one or more processors and one or more code-storing memories coupled with the one or more processors, the processing system configured to cause the network node to:
transmit an indication of a training data configuration for collecting training data that is associated with generation of a beam management inference model;
receive the training data that is based at least in part on the training data configuration;
generate the beam management inference model using the training data; and
transmit, as at least part of a deployment of the beam management inference model, the indication of the training data configuration.

2. The network node of claim 1, wherein the training data configuration indicates at least one of:
a measurement metric type,
a measurement metric threshold,
a periodic measurement logging configuration,
an event-triggered logging configuration,
an event trigger threshold,
a beam-based event,
one or more specific beam identifiers, or
on-demand reporting of logged measurements.

3. The network node of claim 1, wherein the network node is a central unit (CU) and the deployment of the beam management inference model is directed to a distributed unit (DU).

4. The network node of claim 3, wherein the processing system is configured to cause the network node to:
receive a proposed measurement configuration from the DU; and
generate the training data configuration based at least in part on the proposed measurement configuration,
wherein the processing system, to cause the network node to transmit the indication of the training data configuration, is configured to cause the network node to:
transmit an instruction that directs the DU to transmit the indication of the training data configuration in radio resource control signaling that is directed to a user equipment.

5. The network node of claim 3, wherein the processing system is configured to cause the network node to:
configure the DU to request the training data from a user equipment (UE) that is configured based at least in part on the training data configuration.

6. The network node of claim 5, wherein the processing system, to cause the network node to receive the training data, is configured to cause the network node to:
receive the training data from the UE via the DU.

7. The network node of claim 1, wherein the processing system is configured to cause the network node to:
monitor for a measurement request event trigger;
detect an occurrence of the measurement request event trigger; and
request that a distributed unit (DU) configure training data and forward, as at least part of the training data, one or more measurement results based at least in part on detecting the occurrence of the measurement request event trigger.

8. The network node of claim 1, wherein the processing system is configured to cause the network node to:
configure a distributed unit (DU) with one or more layer 1 (L1) measurement request event triggers; and
forward one or more layer 3 measurement results to the DU that are associated with the one or more L1 measurement request event triggers.

9. A method of wireless communication by a network node, the method comprising:
transmitting an indication of a training data configuration for collecting training data that is associated with generation of a beam management inference model;
receiving the training data that is based at least in part on the training data configuration;
generating the beam management inference model using the training data; and
transmitting, as at least part of a deployment of the beam management inference model, the indication of the training data configuration.

10. The method of claim 9 wherein the network node is a central unit (CU) and the deployment of the beam management inference model is directed to a distributed unit (DU).

11. The method of claim 9, further comprising:
selecting one or more user equipments to use for collecting the training data.

12. The method of claim 9, further comprising:
receiving a proposed measurement configuration from a distributed unit (DU); and
generating the training data configuration based at least in part on the proposed measurement configuration,
wherein transmitting the indication of the training data configuration comprises:
transmitting an instruction that directs the DU to transmit the indication of the training data configuration in radio resource control signaling that is directed to a user equipment.

13. The method of claim 9, further comprising:
configuring a distributed unit (DU) to request the training data from a user equipment (UE) that is configured based at least in part on the training data configuration.

14. The method of claim 13, wherein receiving the training data comprises:
receiving the training data from the UE via the DU.

15. The method of claim 14, wherein receiving the training data comprises:
receiving the training data from the UE via radio resource control messaging that is directed to the network node.

16. The method of claim 14, wherein receiving the training data comprises:
receiving the training data from the UE via the DU in physical uplink control channel messaging.

17. The method of claim 9, wherein the network node is a control unit, and wherein the method further comprises:
monitoring for a measurement request event trigger;
detecting an occurrence of the measurement request event trigger; and
requesting that a distributed unit (DU) configure training data and forward, as at least part of the training data, one or more measurement results based at least in part on detecting the occurrence of the measurement request event trigger.

18. A non-transitory computer-readable medium storing a set of instructions for wireless communication, the set of instructions comprising:
one or more instructions that, when executed by one or more processors of a network node, cause the network node to:
transmit an indication of a training data configuration for collecting training data that is associated with generation of a beam management inference model;
receive the training data that is based at least in part on the training data configuration;
generate the beam management inference model using the training data; and
transmit, as at least part of a deployment of the beam management inference model, the indication of the training data configuration.

19. The non-transitory computer-readable medium of claim 18, wherein the one or more instructions further cause the network node to:
receive a proposed measurement configuration from a distributed unit (DU); and
generate the training data configuration based at least in part on the proposed measurement configuration,
wherein the one or more instructions, that cause the network node to transmit the indication of the training data configuration, cause the network node to:
transmit an instruction that directs the DU to transmit the indication of the training data configuration in radio resource control signaling that is directed to a user equipment.

20. The non-transitory computer-readable medium of claim 19, wherein the proposed measurement configuration comprises at least one of:
a set of proposed beams;
a layer 3 measurement metric threshold,
a layer 1 measurement metric threshold,
a periodicity, or
a beam-based even
